(19) United States
(12) Patent Application Publication
(10) Pub. No.: US 2017/0213377 A1
(43) Pub. Date: Jul. 27, 2017

(54) HEAD MOUNTED DISPLAY DEVICE, CONTROL METHOD THEREOF, AND COMPUTER PROGRAM

(71) Applicant: SEIKO EPSON CORPORATION, Tokyo (JP)

(72) Inventors: Shinya TORII, Azumino-shi (JP); Teruhito KOJIMA, Shiojiri-shi (JP); Masahide TAKANO, Matusmoto-shi (JP)

(73) Assignee: SEIKO EPSON CORPORATION, Tokyo (JP)

(21) Appl. No.: 15/514,859

(22) PCT Filed: Sep. 29, 2015
(86) PCT No.: PCT/JP2015/004945

§ 371 Date: Mar. 28, 2017

(30) Foreign Application Priority Data
Oct. 3, 2014 (JP) 2014-204488
May 13, 2015 (JP) 2015-098215

(51) Int. Cl. G06T 11/60; G06F 3/00; G02B 27/01; G06K 9/00; H04N 5/445; H04N 5/232; G06F 3/01; G06K 9/20

(52) U.S. Cl. CPC G06T 11/60; G06F 3/012; G06F 3/005; G06K 9/2063; G06K 9/00671; H04N 5/44513; H04N 5/232; G02B 27/0172; H04N 2005/44526; G02B 2027/014; G02B 2027/0138; G02B 2027/0141

(57) ABSTRACT

A transmission type head mounted display device is provided. The head mounted display device includes an image display unit that displays an image to allow a user wearing the head mounted display device to visually recognize the image and is capable of transmitting external scenery, a use environment determination unit (step S110, step S120) that determines a use environment of the head mounted display device, and a processing control unit (step S160, step S170) that changes at least a portion of a predetermined function built into the head mounted display device in accordance with the determined use environment.

### TECHNICAL FIELD

The present invention relates to a head mounted display device, a control method thereof, and a computer program.

### BACKGROUND ART

In recent years, head mounted display devices which are display devices mounted on a head have been known. The head mounted display device is also referred to as a head mounted display (HMD), and includes a see-through type HMD which allows a user to view external scenery in a state where the user wears the HMD. The see-through type HMD reflects image light, which is generated by an optical modulation element such as a liquid crystal panel, using an optical system or the like which is disposed in front of the eyes of a user to thereby display an image as a virtual image together with external scenery (real image) in the visual field area of the user (for example, PTL 1).

### CITATION LIST

### Patent Literature

### [PTL 1]

JP-A-2010-139901

### SUMMARY OF INVENTION

### Technical Problem

Hitherto, a see-through type HMD having various functions, as well as a function of displaying the image, has been proposed. The various functions include a photographing function using a camera, a function of outputting a sound, and the like. There is a problem in that it has not been sufficiently examined whether these functions may be operated at all times. In addition, in a head mounted display device of the related art, there have been demands for an improvement in user convenience, an improvement in detection accuracy, the prevention of malicious use such as surreptitious photographing, the compactification of a device configuration, a reduction in cost, resource saving, manufacturing facilitation, and the like.

### Solution to Problem

An advantage of some aspects of the invention is to solve at least a part of the problems described above, and the invention can be implemented as the following forms.

(1) An aspect of the invention is directed to a transmission type head mounted display device. The head mounted display device includes an image display unit that displays an image to allow a user wearing the head mounted display device to visually recognize the image and is capable of transmitting external scenery, a use environment determination unit that determines a use environment of the head mounted display device, and a processing control unit that changes at least a portion of a predetermined function built into the head mounted display device in accordance with the determined use environment. According to the head mounted display device of this aspect, at least a portion of the predetermined function built into the head mounted display device may be changed in accordance with the use environment of the head mounted display device worn on the user. For this reason, changes such as the suppression or extension of at least a portion of the predetermined function built into the head mounted display device are performed in accordance with the use environment. Therefore, according to the head mounted display device of this aspect, it is possible to easily implement a function corresponding to the use environment.

(2) In the head mounted display device according to the aspect, the use environment may be a use environment which is changed by movement of the head mounted display device. According to the transmission type head mounted display device, a user can freely move while wearing the head mounted display device, and thus a use environment is changeable. Therefore, according to the head mounted display device of this aspect, it is possible to easily implement a function corresponding to the changeable use environment.

(3) The head mounted display device according to the aspect may further include an image capturing unit that performs image capturing, and the use environment determination unit may determine the use environment on the basis of a captured image obtained by the image capturing unit. The image capturing unit is included in the head mounted display device, and thus an image capturing range moves in association with the movement of a user's head. Therefore, it is possible to easily detect a change in a use environment from the captured image obtained by the image capturing unit.

(4) In the head mounted display device according to the aspect, when a marker for recognizing a specific use environment is included in the captured image obtained by the image capturing unit, the use environment determination unit may determine the specific use environment. According to the head mounted display device of this aspect, it is possible to easily detect a change in a use environment by capturing an image of the marker.

(5) In the head mounted display device according to the aspect, the use environment determination unit may determine the use environment on the basis of a signal from an external wireless communication terminal. According to the head mounted display device of this aspect, it is possible to easily detect a use environment.

(6) In the head mounted display device according to the aspect, the predetermined function may be a telephotographing function of performing telephotographing using a camera unit. According to the head mounted display device of this aspect, it is possible to suppress or extend the telephotographing function using the camera unit. Therefore, it is possible to easily perform a change to a telephotographing mode according to a use environment.

(7) In the head mounted display device according to the aspect, the use environment may include at least a specific seat environment in a sports stadium, and when the use environment determination unit determines the specific seat environment, the processing control unit may turn on the telephotographing function to perform telephotographing using the camera unit. According to the head mounted display device of this aspect, telephotographing is automatically performed in the specific seat environment in the stadium, and thus a user can freely reproduce a captured image recorded through the telephotographing. Therefore, it is possible to increase user convenience in a specific seat environment in a sports stadium.

(8) The head mounted display device according to the aspect may further include an erasure unit that erases a captured image recorded through the telephotographing when movement of the head mounted display device to the outside of the sports stadium is detected. According to the head mounted display device of this aspect, it is possible to prevent a captured image captured in a specific seat environment in a sports stadium from being carried out of the sports stadium.

(9) In the head mounted display device according to the aspect, when the use environment determination unit determines a predetermined use environment, the processing control unit may acquire predetermined data and store the data in a storage unit, and when the use environment determination unit determines separation from the predetermined use environment, the predetermined data stored in the storage unit in the predetermined use environment may erased. According to the head mounted display device of this aspect, it is possible to erase the predetermined data stored in the predetermined use environment when the predetermined data is separated from the predetermined use environment. Therefore, according to the head mounted display device of this aspect, a use range of the predetermined data can be restricted to be under the predetermined use environment, and thus it is possible to achieve an improvement in security.

(10) In the head mounted display device according to the aspect, the predetermined function may be an information presentation function of displaying predetermined information on the image display unit. According to the head mounted display device of this aspect, it is possible to suppress or extend the information presentation function of displaying the predetermined information on the image display unit. Therefore, it is possible to easily perform information presentation suitable for the occasion.

(11) In the head mounted display device according to the aspect, the use environment may include at least a specific seat environment in a theater, and when the use environment determination unit determines the specific seat environment, the processing control unit may display guidance information regarding a play which is being performed in a theater as the predetermined information. According to the head mounted display device of this aspect, in a case of transition to the specific seat environment in a theater, it is possible to present guidance information regarding a play which is being performed in a theater to a user through image display. Therefore, it is possible to easily present information regarding a play.

(12) In the head mounted display device according to the aspect, the use environment may include at least a specific seat environment in a movie theater, and when the use environment determination unit determines the specific seat environment, the processing control unit may display subtitles as the predetermined information. According to the head mounted display device of this aspect, in a case of transition to the specific seat environment in a movie theater, it is possible to present the subtitles of a movie which is being shown to a user through image display. Therefore, it is possible to easily present information regarding subtitles.

(13) In the head mounted display device according to the aspect, the specific seat environment in the movie theater may include a first coordinate environment and a second coordinate environment, and the processing control unit may display the subtitles written in a first language when the use environment determination unit determines the first seat environment, and may display the subtitles written in a second language different from the first language when the use environment determination unit determines the second seat environment. According to the head mounted display device of this aspect, it is possible to receive subtitles written in the first language in a case of transition to the first seat environment in the movie theater and to receive subtitles written in the second language in a case of transition to the second seat environment in the movie theater. Therefore, it is possible to easily change the language of the subtitles in accordance with a seat environment.

(14) In the head mounted display device according to the aspect, the use environment may include at least a security environment requiring high level security, and the processing control unit may permit execution of a predetermined application when the use environment determination unit determines the security environment, and may prohibit execution of the predetermined application when the use environment determination unit determines not to be the security environment. According to the head mounted display device of this aspect, the execution of a predetermined application is permitted in a case of transition to the security environment requiring high level security, the execution of the predetermined application is prohibited in a case of not being in the security environment. Therefore, it is possible to easily change the permission and prohibition of the execution of a predetermined application in accordance with a security environment.

(15) In the head mounted display device according to the aspect, the use environment may be a public space. According to the head mounted display device of this aspect, it is possible to change at least a portion of a predetermined function in a case of a public space.

(16) In the head mounted display device according to the aspect, when the use environment determination unit determines the public space, the processing control unit may prohibit image capturing using an image sensor device according to a predetermined application. According to the head mounted display device of this aspect, it is possible to prohibit image capturing using the image sensor device in a case of a public space.

(17) The head mounted display device according to the aspect may further include a storage unit that stores an operation program and a predetermined application program, a predetermined device that is capable of operating by a predetermined function implemented by the operation program, and a device control unit that drives the predetermined device by exclusively using the predetermined function. According to the head mounted display device of this aspect, it is possible to exclusively use the predetermined device through the device control unit. That is, the predetermined application program cannot use the predetermined device without going through the device control unit. Therefore, it is possible to increase adaptability to society by restricting the use of the device control unit.

All of the plurality of constituent elements in the respective aspects of the invention described above are not essential, and some of the plurality of constituent elements may be appropriately changed, deleted, exchanged with other new constituent elements, and partially deleted from limited content thereof in order to solve some or all of the above-described problems or in order to achieve some or all of the effects described in the present specification. In addition, in order to solve some or all of the above-described problems or in order to achieve some or all of the effects described in the present specification, some or all of the technical features included in one aspect of the invention described above may be combined with some or all of the technical features included in another aspect of the invention described above, and as a result may be treated as an independent aspect of the invention.

For example, one aspect of the invention may be implemented as a device which includes one or more or all of the three constituent elements including an image display unit, a use environment determination unit, and a processing control unit. That is, this device may or may not include the image display unit. In addition, the device may or may not include the use environment determination unit. Further, the device may or may not include the processing control unit. For example, the image display unit may be configured to display an image to allow a user wearing a head mounted display device to visually recognize the image, and to be capable of transmitting external scenery. The use environment determination unit may determine, for example, the use environment of the head mounted display device. The processing control unit may change at least a portion of a predetermined function built into the head mounted display device, for example, in accordance with the determined use environment. Such a device can be implemented as, for example, a head mounted display device, but may also be implemented as devices other than the head mounted display device. According to the aspect, it is possible to solve at least one of various problems such as an improvement in user convenience, an improvement in detection accuracy, the prevention of malicious use such as surreptitious photographing, the compactification of a device configuration, a reduction in cost, resource saving, and manufacturing facilitation. Some or all of the above-described technical features of each aspect of the head mounted display device are applicable to the device.

The invention may be implemented in various forms other than the head mounted display device. For example, the invention may be implemented in forms such as a display device, a head mounted display device, and a method of controlling the display device, and a head mounted display system, a display device, a computer program for implementing the head mounted display system and the display device, a recording medium for recording the computer program thereon, and data signal that includes the computer program and is implemented within a carrier wave.

### BRIEF DESCRIPTION OF DRAWINGS

FIG. 1 is a diagram illustrating a schematic configuration of a head mounted display device (HMD) according to a first embodiment.

FIG. 2 is a functional block diagram illustrating a configuration of the HMD.

FIG. 3 is a diagram illustrating an example of a virtual image which is visually recognized by a user.

FIG. 4 is a diagram illustrating a platform of the HMD.

FIG. 5 is a diagram illustrating a ticket for watching soccer according to the first embodiment.

FIG. 6 is a diagram illustrating an example of information which is visually recognized by a user when a QR cord is read with his or her eyes turning to a ticket for watching soccer.

FIG. 7 is a flow chart illustrating details of a watching auxiliary routine.

FIG. 8 is a diagram illustrating an example of information which is visually recognized by a user when a captured moving image is reproduced.

FIG. 9 is a diagram illustrating a using mode of an HMD according to a second embodiment.

FIG. 10 is a flow chart illustrating details of an appreciation auxiliary routine according to the second embodiment.

FIG. 11 is a diagram illustrating a using mode of an HMD according to a third embodiment.

FIG. 12 is a flow chart illustrating details of an appreciation auxiliary routine according to the third embodiment.

FIG. 13 is a diagram illustrating a using mode of an HMD according to a fourth embodiment.

FIG. 14 is a diagram illustrating a using mode of an HMD according to a fifth embodiment of the invention.

FIG. 15 is a flow chart illustrating a society adaptation supporting routine which is executed by an HMD according to a sixth embodiment of the invention.

FIG. 16 is a diagram illustrating a public toilet.

FIG. 17 is a diagram illustrating a priority seat in a train.

FIG. 18 is a diagram illustrating a platform of an HMD according to a seventh embodiment of the invention.

FIG. 19A is a diagram illustrating an exterior configuration of a HMD according to a modification example.

FIG. 19B is a diagram illustrating an exterior configuration of an HMD according to a modification example.

### DESCRIPTION OF EMBODIMENTS

### A. First Embodiment

### A-1. Configuration of Head Mounted Display Device

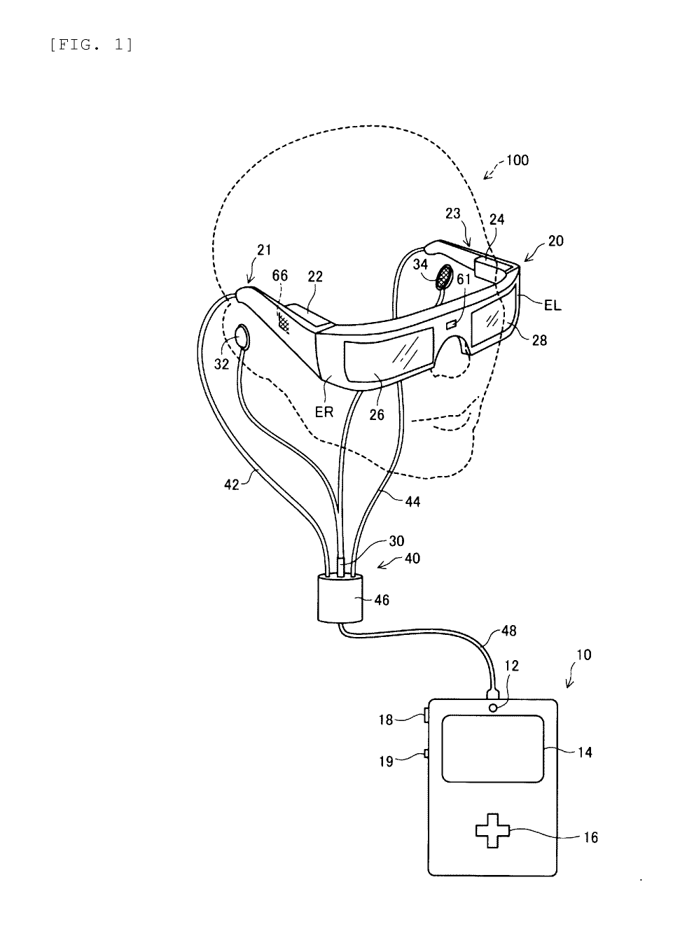

FIG. 1 is a diagram illustrating a schematic configuration of a head mounted display device according to a first embodiment. A head mounted display device 100 is a display device which is mounted on a head and is also referred to as a head mounted display (HMD). The HMD 100 is an optical transmission type head mounted display allowing a user to visually recognize a virtual image and to visually recognize external scenery directly, and is used to watch a game (for example, soccer) in this embodiment.

The HMD 100 includes an image display unit 20 that allows a user to visually recognize a virtual image in a state where the image display unit is mounted on a user's head, and a control unit (controller) 10 that controls the image display unit 20.

The image display unit 20 is a mounted body which is mounted on a user's head, and has a spectacle shape in this embodiment. The image display unit 20 includes a right holding portion 21, a right display driving portion 22, a left holding portion 23, a left display driving portion 24, a right optical image display portion 26, and a left optical image display portion 28. The right optical image display portion 26 and the left optical image display portion 28 are disposed so as to be positioned in front of the user's right eye and the user's left eye, respectively, when the user wears the image display unit 20. One end of the right optical image display portion 26 and one end of the left optical image display portion 28 are connected to each other at a position corresponding to the user's glabella when the user wears the image display unit 20.

The right holding portion 21 is a member provided to extending from an end ER, which is the other end of the right optical image display portion 26, to a position corresponding to the user's temporal region when the user wears the image display unit 20. Similarly, the left holding portion 23 is a member provided to extend from an end EL, which is the other end of the left optical image display portion 28, to a position corresponding to the user's temporal region when the user wears the image display unit 20. The right holding portion 21 and the left holding portion 23 hold the image display unit 20 on the user's head in a manner of temples (bows) of spectacles.

The right display driving portion 22 is disposed on the inner side of the right holding portion 21, in other words, on the side facing the user's head when the user wears the image display unit 20. In addition, the left display driving portion 24 is disposed on the inner side of the left holding portion 23. Hereinafter, a description will be given by referring to the right holding portion 21 and the left holding portion 23 as “holding units” without making a distinction therebetween. Similarly, a description will be given by referring to the right display driving portion 22 and the left display driving portion 24 as “display driving portions” without making a distinction therebetween and by referring to the right optical image display portion 26 and the left optical image display portion as “optical image display portions” without making a distinction therebetween.

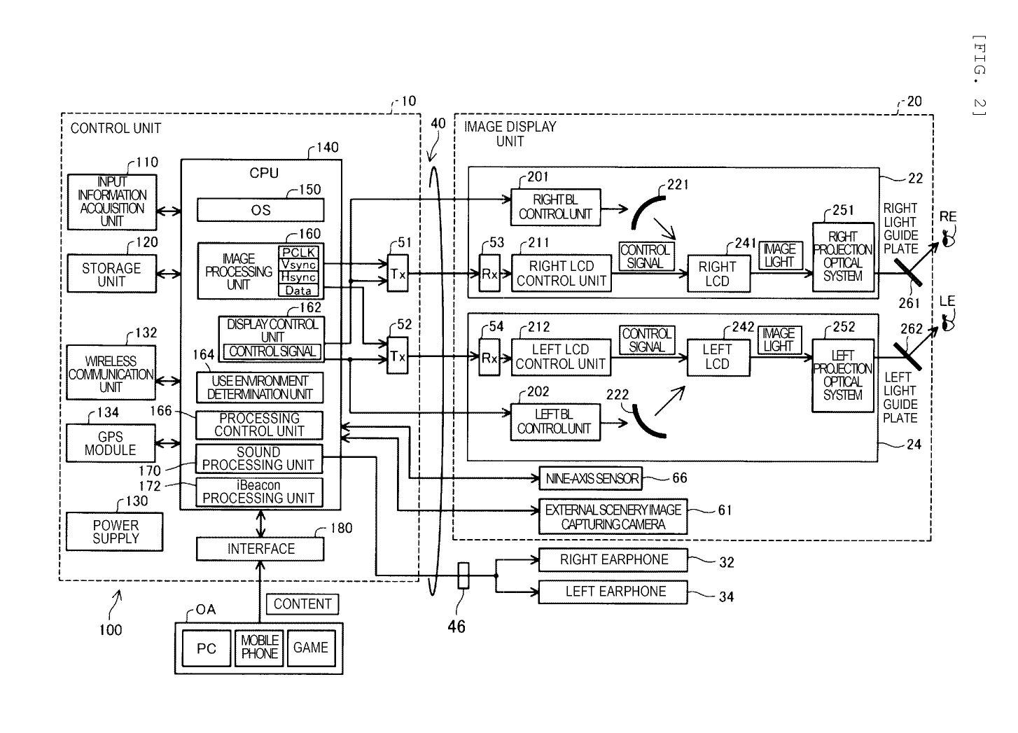

The display driving portion includes liquid crystal displays (hereinafter, referred to as “LCD”) 241 and 242, projection optical systems 251 and 252, and the like (see FIG. 2). The configuration of the display driving portion will be described later in detail. The optical image display portion as an optical member includes light guide plates 261 and 262 (see FIG. 2) and a light control plate. The light guide plates 261 and 262 are formed of a light transmissive resin material or the like, and guide image light which is output from the display driving portion to user's eyes. The light control plate is an optical element having a thin plate shape, and is disposed so as to cover the front (side opposite to user's eyes) of the image display unit 20. The light control plate protects the light guide plates 261 and 262, and suppresses damages of the light guide plates 261 and 262, the adhesion of dirt, and the like. In addition, the light transmittance of the light control plate is adjusted, and thus it is possible to adjust the easiness of visual recognition of a virtual image by adjusting the amount of external light entering user's eyes. Meanwhile, the light control plate can be omitted.

The image display unit 20 further includes a connection unit 40 for connecting the image display unit 20 to the control unit 10. The connection unit 40 includes a main cord 48 connected to the control unit 10, a right cord 42 and a left cord 44 into which the main cord 48 branches, and a connection member 46 provided at a branch point. The right cord 42 is connected to the right display driving portion 22, and the left cord 44 is connected to the left display driving portion 24. The connection member 46 is provided with a jack for connection to an earphone plug 30. Aright earphone 32 and a left earphone 34 extend from the earphone plug 30.

The image display unit 20 and the control unit 10 perform the transmission of various signals through the connection unit 40. An end of the main cord 48 which is opposite to the connection member 46 and the control unit 10 are provided with respective connectors (not shown) which are fitted to each other, and thus the control unit 10 and the image display unit 20 are connected to each other or disconnected from each other by fitting or the release of fitting of the connector of the main cord 48 and the connector of the control unit 10. For example, a metal cable or an optical cable can be adopted as the right cord 42, the left cord 44, and the main cord 48.

The control unit 10 is a device for controlling the HMD 100. The control unit 10 includes a lighting portion 12, a touch pad 14, a cross key 16, and a power switch 18. The lighting portion 12 notifies an operation state (for example, ON/OFF of a power supply) of the HMD 100 according to the emission mode thereof. For example, a light emitting diode (LED) can be used as the lighting portion 12. The touch pad 14 detects a contact operation on an operation surface of the touch pad 14 and outputs a signal based on detection contents. Various types of touch pads such as an electrostatic type, a pressure detection type, or an optical type can be adopted as the touch pad 14. The cross key 16 detects key pressing operations corresponding to horizontal and vertical directions, and outputs a signal based on detection contents. The power switch 18 detects a switch sliding operation to thereby switch the state of the power supply of the HMD 100.

FIG. 2 is a functional block diagram illustrating the configuration of the HMD 100. The control unit 10 includes an input information acquisition unit 110, a storage unit 120, a power supply 130, a wireless communication unit 132, a GPS module 134, a CPU 140, an interface 180, and transmission units (Tx) 51 and 52, and the units are connected to each other by a bus not shown in the drawing.

The input information acquisition unit 110 acquires signals based on operation inputs of, for example, the touch pad 14, the cross key 16, and the power switch 18. The storage unit 120 is constituted by a ROM, a RAM, a DRAM, a hard disk, or the like.

The power supply 130 supplies power to the units of the HMD 100. A secondary battery such as, for example, a lithium polymer battery and a lithium-ion battery can be used as the power supply 130. Further, instead of the secondary battery, a primary battery or a fuel cell may be used, and operation may be performed by receiving power in a wireless manner. Further, power may be received from a solar cell and a capacitor. The wireless communication unit 132 performs wireless communication with another apparatus according to a predetermined wireless communication standard such as a wireless LAN, Bluetooth (registered trademark), or iBeacon (registered trademark). The GPS module 134 receives a signal from a GPS satellite to thereby detect its own present position.

The CPU 140 functions as an operating system (OS) 150, an image processing unit 160, a display control unit 162, a use environment determination unit 164, a processing control unit 166, a sound processing unit 170, and an iBeacon processing unit 172 by reading out and executing a computer program which is stored in the storage unit 120.

The image processing unit 160 generates a signal on the basis of a content (video) which is input through the interface 180 and the wireless communication unit 132. The image processing unit 160 controls the image display unit 20 by supplying the generated signal to the image display unit 20 through the connection unit 40. The signal supplied to the image display unit 20 varies depending on the case of an analog form or the case of a digital form. In the case of an analog form, the image processing unit 160 generates and transmits a clock signal PCLK, a vertical synchronization signal VSync, a horizontal synchronization signal HSync, and image data Data. Specifically, the image processing unit 160 acquires an image signal included in the content. In general, the acquired image signal is an analog signal constituted by thirty frame images per second, for example, in the case of a moving image. The image processing unit 160 separates a synchronization signal such as a vertical synchronization signal VSync or a horizontal synchronization signal HSync from the acquired image signal, and generates a clock signal PCLK by a PLL circuit or the like. The image processing unit 160 converts the analog image signal from which the synchronization signal is separated, into a digital image signal using an A/D conversion circuit or the like. The image processing unit 160 stores the converted digital image signal in a DRAM within the storage unit 120 for each fram, as image data Data of RGB data.

On the other hand, in the case of a digital form, the image processing unit 160 generates and transmits a clock signal PCLK and image data Data. Specifically, when a content has a digital form, the clock signal PCLK is output in synchronization with an image signal, and thus the generation of a vertical synchronization signal VSync and a horizontal synchronization signal HSync and the A/D conversion of an analog image signal are not required. Meanwhile, the image processing unit 160 may perform image processing such as a resolution conversion process, various color tone correction processes such as the adjustment of luminance and chroma, and a keystone correction process on the image data Data stored in the storage unit 120.

The image processing unit 160 transmits the generated clock signal PCLK, vertical synchronization signal VSync, and horizontal synchronization signal HSync and the image data Data stored in the DRAM within the storage unit 120 through the transmission units 51 and 52, respectively. Meanwhile, image data Data transmitted through the transmission unit 51 is also referred to as “image data Data1 for the right eye”, and image data Data transmitted through the transmission unit 52 is also referred to as “image data Data2 for the right eye”. The transmission units 51 and 52 function as transceivers for serial transmission between the control unit 10 and the image display unit 20.

The display control unit 162 generates a control signal for controlling the right display driving portion 22 and the left display driving portion 24. Specifically, the display control unit 162 controls the generation and emission of image light which are performed by the right display driving portion 22 and the left display driving portion 24 by individually controlling ON/OFF of driving of the right LCD 241 using the right LCD control unit 211, ON/OFF of driving of the right backlight 221 using the right backlight control unit 201, ON/OFF of driving of the left LCD 242 using the left LCD control unit 212, ON/OFF of driving of the left backlight 222 using the left backlight control unit 202, and the like in response to the control signal. The display control unit 162 transmits control signals for the right LCD control unit 211 and the left LCD control unit 212 through the transmission unit 51 and 52, respectively. Similarly, the display control unit 162 transmits control signals for the right backlight control unit 201 and the left backlight control unit 202.

The use environment determination unit 164 determines a movement environment which changes by the movement of the HMD 100 mounted on a user's head. The processing control unit 166 changes at least a portion of a predetermined function among various functions built into the HMD 100. The predetermined function may be one function or a plurality of functions, but is one function in the first embodiment. The use environment determination unit 164 and the processing control unit 166 will be described later in detail.

The sound processing unit 170 acquires a sound signal included in a content, amplifies the acquired sound signal, and supplies the acquired sound signal to a speaker, not shown in the drawing, within the right earphone 32 connected to the connection member 46 and a speaker, not shown in the drawing, within the left earphone 34. For example, when a Dolby (registered trademark) system is adopted, processing is performed on the sound signal, and different sounds, for example, having changed frequency are output from the right earphone 32 and the left earphone 34, respectively.

The iBeacon processing unit 172 receives a signal from a Bluetooth low energy (BLE) terminal provided outside the HMD 100 by using an iBeacon (registered trademark) technique to thereby obtain a distance between the BLE terminal and the HMD 100.

The interface 180 is an interface for connecting various external apparatuses OA, serving as content supply sources, to the control unit 10. Examples of the external apparatus OA include a personal computer PC, a mobile phone terminal, a game terminal, and the like. Examples of the interface 180 can include a USB interface, a micro USB interface, an interface for a memory card, and the like.

The image display unit 20 includes a right display driving portion 22, a left display driving portion 24, a right light guide plate 261 as the right optical image display portion 26, a left light guide plate 262 as the left optical image display portion 28, an external scenery image capturing camera 61 (also see FIG. 1), and a nine-axis sensor 66.

The external scenery image capturing camera 61 is disposed at a position corresponding to a user's glabella when the user wears the image display unit 20. For this reason, the external scenery image capturing camera 61 captures an image of external scenery which is an external scene in a direction in which the user faces, in a state where the user wears the image display unit 20 on his or her head. The external scenery image capturing camera 61 is a monocular camera, but may be a stereo camera. Meanwhile, in this embodiment, the external scenery image capturing camera 61 has a telescopic function, and thus can perform image capturing in a telescopic mode. The telescopic function may be a function using either optical zooming or digital zooming. Further, an external camera through USB connection or the like can also be used instead of the external scenery image capturing camera 61.

The nine-axis sensor 66 is a motion sensor that detects acceleration (three axes), angular velocity (three axes), and terrestrial magnetism (three axes), and is disposed at a position corresponding to the user's right temple in this embodiment. The nine-axis sensor 66 is provided in the image display unit 20, and thus detects the movement of the user's head when the image display unit 20 is mounted on the user's head. The orientation of the image display unit 20 is specified from the detected movement of the user's head.

The right display driving portion 22 includes a reception unit (Rx) 53, the right backlight (BL) control unit 201 and the right backlight (BL) 221 which function as light sources, the right LCD control unit 211 and the right LCD 241 which function as display elements, and the right projection optical system 251. Meanwhile, the right backlight control unit 201, the right LCD control unit 211, the right backlight 221, and the right LCD 241 are also collectively referred to as an “image light generation unit”.

The reception unit 53 functions as a receiver for performing serial transmission between the control unit 10 and the image display unit 20. The right backlight control unit 201 drives the right backlight 221 on the basis of an input control signal. The right backlight 221 is an emission body such as, for example, an LED or an electroluminescence (EL). The right LCD control unit 211 drives the right LCD 241 on the basis of the clock signal PCLK, the vertical synchronization signal VSync, the horizontal synchronization signal HSync, and the image data Data1 for the right eye which are input through the reception unit 53. The right LCD 241 is a transmission type liquid crystal panel in which a plurality of pixels are disposed in a matrix. The right LCD 241 modulates illumination light emitted from the right backlight 221 to effective image light representing an image by driving liquid crystal at pixel positions disposed in a matrix and changing the transmittance of light passing through the right LCD 241.

The right projection optical system 251 is constituted by a collimator lens that forms image light emitted from the right LCD 241 into light flux in a parallel state. The right light guide plate 261 as the right optical image display portion 26 guides image light output from the right projection optical system 251 to a user's right eye RE while reflecting the image light along a predetermined light path. The optical image display portion can use any method along as it forms a virtual image in front of user's eyes using image light, and may use, for example, a diffraction grating or may use a translucent reflection film. Meanwhile, the emission of image light from the HMD 100 is also referred to as “display of an image” in this specification.

The left display driving portion 24 has the same configuration as the right display driving portion 22. That is, the left display driving portion 24 includes a reception unit (Rx) 54, the left backlight (BL) control unit 202 and the left backlight (BL) 222 which function as light sources, the left LCD control unit 212 and the left LCD 242 which function as display elements, and the left projection optical system 252. Similarly to the right LCD 241, the left LCD 242 modulates illumination light emitted from the left backlight 222 to effective image light representing an image by driving liquid crystal of pixel positions disposed in a matrix and changing the transmittance of light passing through the left LCD 242. Although a backlight system is adopted in this embodiment, image light may be emitted using a front light system or a reflection system.

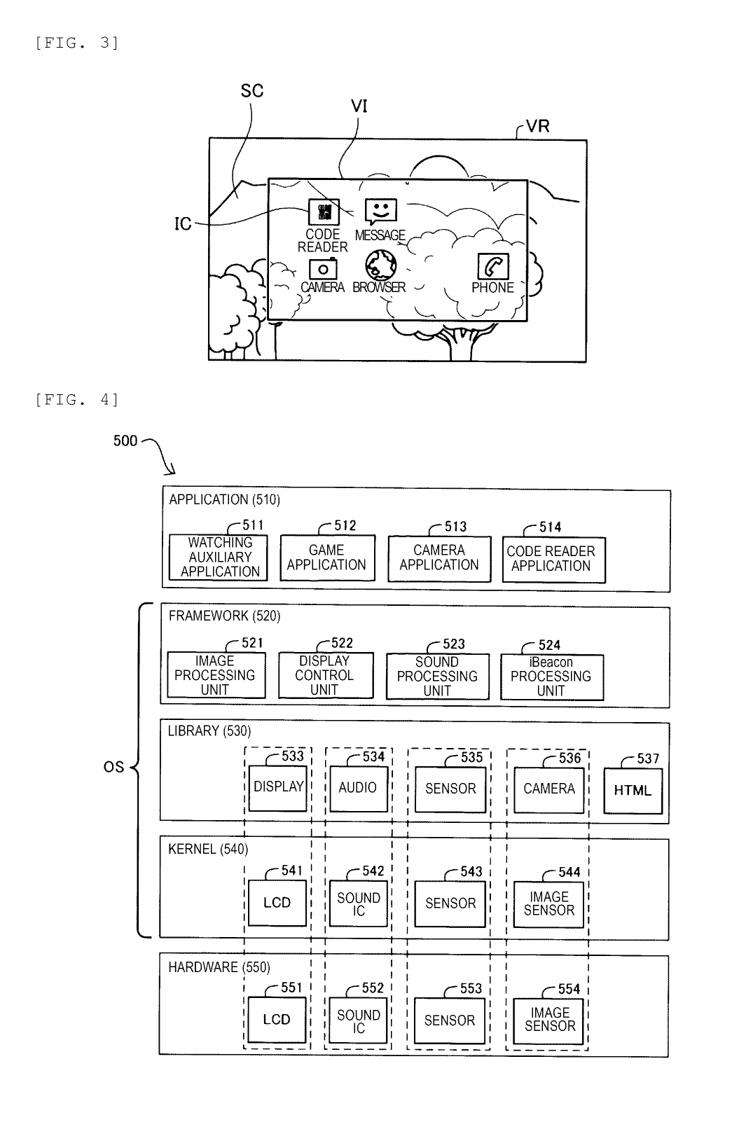

FIG. 3 is a diagram illustrating an example of a virtual image which is visually recognized by a user. In FIG. 3, a user's visual field VR is illustrated. As described above, image light beams guided to user's both eyes of the HMD 100 are formed on the user's retinas, respectively, and thus the user visually recognizes a virtual image (image) VI. In an example of FIG. 3, the virtual image VI is a standby image of the OS of the HMD 100. In addition, the user visually recognizes an external scenery SC through the right optical image display portion 26 and the left optical image display portion 28. In this manner, the user of the HMD of this embodiment can view the virtual image VI and the external scenery SC behind the virtual image VI with respect to a portion of the visual field VR in which the virtual image VI is displayed. In addition, the user can directly view the external scenery SC through the optical image display portion with respect to a portion of the visual field VR1 in which the virtual image VI is not displayed.

### A-2. Platform of HMD

FIG. 4 is a diagram illustrating a platform of the HMD 100. The term “platform” used herein refers to a set of a hardware resource, an OS, middleware, and the like which are foundations required to operate an application installed in the HMD 100. A platform 500 of this embodiment includes an application layer 510, a framework layer 520, a library layer 530, a kernel layer 540, and a hardware layer 550. In the layers 510 to 550, a hardware resource, an OS, middleware, and the like which are included in the platform 500 are conceptually divided into layers. Functions of the OS 150 (FIG. 2) are implemented by the framework layer 520, the library layer 530, and the kernel layer 540. Meanwhile, in FIG. 4, constituent elements which are unnecessary in the description will not be illustrated.

The application layer 510 is a set of pieces of application software for performing predetermined processing on the OS 150. Hereinafter, each application software included in the application layer 510 will also be referred to as an “app” or an “application”. The application layer 510 includes both an app installed in the HMD 100 in advance and an app installed by a user of the HMD 100.

In an example of FIG. 4, the application layer 510 includes a watching auxiliary app 511, a game app 512, a camera app 513, a code reader app 514, and the like. The watching auxiliary app 511 provides a watching auxiliary function suitable for watching at a large-scale sports stadium (stadium). The game app 512 provides a game function. The camera app 513 provides a photographing function.

The framework layer 520 is a set of a basic program structure, which is common to the pieces of application software of the application layer 510, and a program equipped with a function set. In this embodiment, an image processing unit frame 521, a display control unit frame 522, a sound processing unit frame 523, an iBeacon processing unit frame 524, and the like are included. The image processing unit frame 521 implements the function of the image processing unit 160 (FIG. 2). The display control unit frame 522 implements the function of the display control unit 162 (FIG. 2). The sound processing unit frame 523 implements the function of the sound processing unit 170 (FIG. 2). The iBeacon processing unit frame 524 implements the function of the iBeacon processing unit 172 (FIG. 2).

The library layer 530 is a set of pieces of library software that are configured as components so that a program for implementing a specific function can be used from another program (for example, an app of the application layer 510). Hereinafter, each library software included in the library layer 530 will also be referred to as a “library”. The library cannot be independently executed, and is executed in a manner of being called from another program.

In the example of FIG. 4, the library layer 530 includes a display library 533, an audio library 534, a sensor library 535, a camera library 536, a hyper text markup language (HTML) library 537, and the like. The display library 533 drives the right LCD 241 and the left LCD 242 (FIG. 2). The audio library 534 drives a sound integrated circuit (IC) built into the right earphone 32 and the left earphone 34 (FIG. 2). The sensor library 535 drives the nine-axis sensor 66 (FIG. 2), acquires a detected value using the nine-axis sensor 66, and processes the detected value into information to be provided to an app. The camera library 536 drives the external scenery image capturing camera 61 (FIG. 2), acquires a detected value using the external scenery image capturing camera 61, and generates an external scenery image from the detected value. The HTML library 537 analyzes data written in a language for a web page description to thereby calculate the arrangement of a character and an image for screen display.

The kernel layer 540 is a set of programs equipped with a basic function of the OS 150. The kernel layer 540 manages communication between software (library layer 530) and hardware (hardware layer 550), and functions as an intermediator therebetwen.

In the example of FIG. 4, the kernel layer 540 includes an LCD driver 541 for the right LCD 241 and the left LCD 242, a sound IC driver 542 for a sound IC, a sensor driver 543 for the nine-axis sensor 66, and an image sensor driver 544 for an image sensor which is built into the external scenery image capturing camera 61.

The hardware layer 550 is a real hardware resource embedded in the HMD 100. The phrase “hardware resource” used in this embodiment refers to a device which is connected to the HMD 100 and is embedded in the HMD 100. That is, the hardware resource includes both a device (for example, a sensor device of the nine-axis sensor 66, an image sensor device of the camera 61, or a sensor device of the touch pad 14) which is internally connected to a motherboard of the HMD 100 and a device (for example, an external motion sensor device or an external USB device) which is externally connected to the HMD 100 through the interface 180.

In the example of FIG. 4, the hardware layer 550 includes an LCD device 551 as the right LCD 241 and the left LCD 242, a sound IC device 552, a sensor device 553 of the nine-axis sensor 66, and an image sensor device 554 of the external scenery image capturing camera 61.

A library, a driver, and a device which are surrounded by a dashed line in FIG. 4 have a correspondence, and thus operate in cooperation with each other. For example, the sensor library 535, the sensor driver 543, and the sensor device 553 operate in cooperation with each other in order to implement the function of the nine-axis sensor 66. That is, it can be said that the sensor library 535 of the library layer 530 and the sensor driver 543 of the kernel layer 540 are programs (software) causing an app to use the sensor device 553 as a hardware resource (hardware layer 550). Meanwhile, in order to make it possible to use the sensor device 553 as one hardware resource, a configuration may be adopted in which a plurality of libraries are allocated to the sensor device 553.

On the other hand, in FIG. 4, for example, the HTML library 537 of the library layer 530 does not have a correspondence relationship with a hardware resource, and is not dependent on the hardware resource. In this manner, a program (software) which is embedded in the HMD 100 and is not dependent on a hardware resource is also referred to as a “software resource” in this embodiment. As the software resource, various programs included in the layers including the framework layer 520, the library layer 530, and the kernel layer 540 are assumed.

### A-3. Methods of Ticket for Watching and Start of App

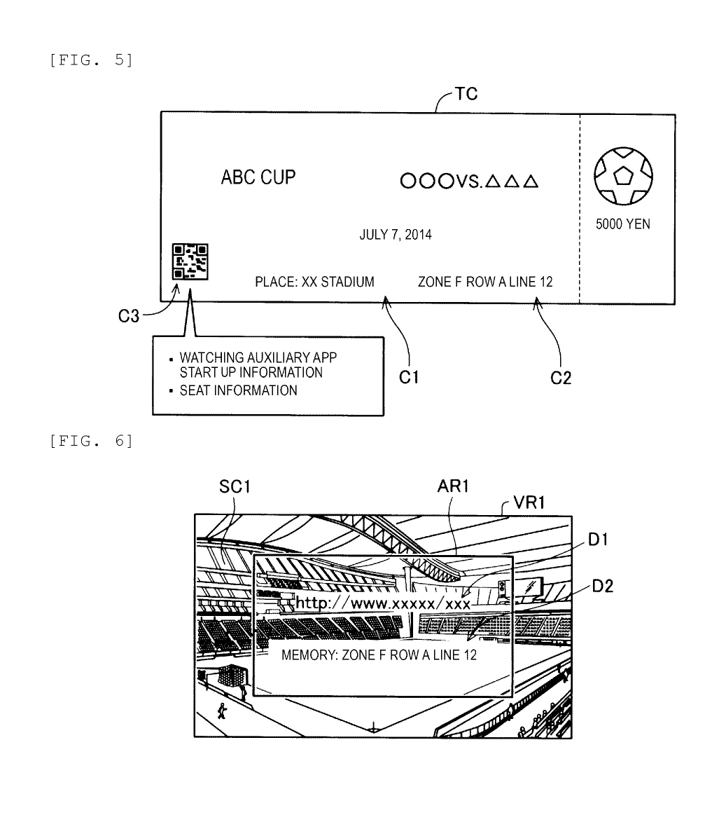

FIG. 5 is a diagram illustrating a ticket for watching soccer according to this embodiment. A place name C1, seat information C2 indicating a seat location, a QR cord (registered trademark) C3, and the like are printed on a ticket for watching soccer TC. Start information (hereinafter, referred to as “watching auxiliary app start information”) for starting the watching auxiliary app 511 (FIG. 4) and seat information are coded and recorded in the QR cord C3.

A user wearing the HMD 100 starts the code reader app 514 in a stadium and turns his or her eyes to the ticket TK which is presented at the time of admission. The code reader app 514 is started by the input information acquisition unit 110 receiving a predetermined operation of selecting a [code reader] icon IC disposed in the standby image (see FIG. 3) of the HMD 100. The HMD 100 executing the code reader app 514 performs image capturing using the external scenery image capturing camera 61. When a QR cord is included in a captured image obtained, the HMD restores the QR cord to the original information, and displays the original information. That is, when the QR cord is included in the captured image, the CPU 140 displays information which is coded as the QR cord on the image display unit 20.

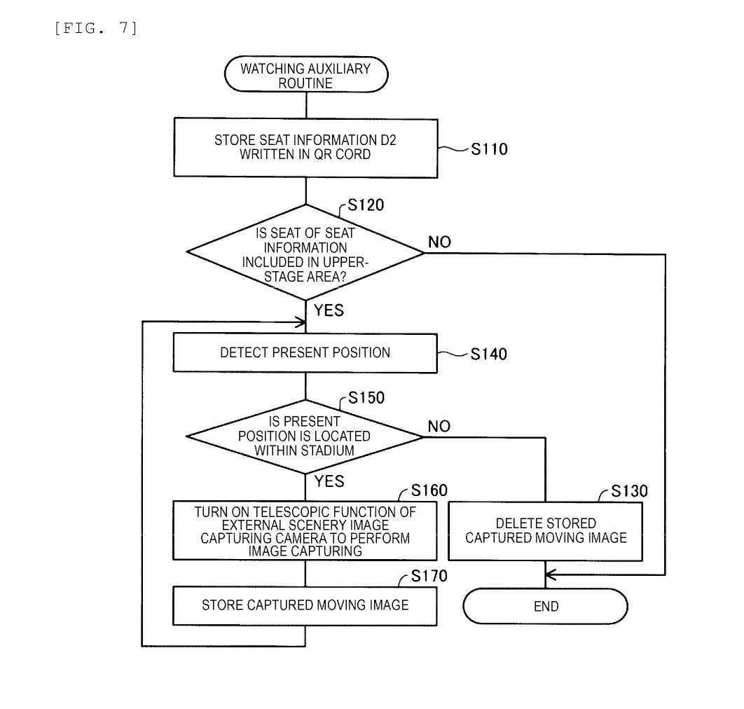

FIG. 6 is a diagram illustrating an example of information which is visually recognized by a user when the QR cord C3 is read with his or her eyes turning to a ticket TC for watching soccer. FIG. 6 illustrates a user's visual field VR1. As illustrated in the drawing, the visual field VR1 includes an external scenery SC1 in a stadium. In addition, a cord information display region AR1 is disposed so as to be superimposed on the external scenery SC1. The cord information display region AR1 includes watching auxiliary app start information D1 and seat information D2 which are pieces of original information of the QR cord 511.

A user performs a predetermined operation of selecting the watching auxiliary app start information D1 using the touch pad 14 or the cross key 16. The input information acquisition unit 110 receives the predetermined operation, and thus the HMD 100 can start the watching auxiliary app 511 (FIG. 4). Specifically, the HMD 100 installs a watching auxiliary app by tracing an URL written in the watching auxiliary app start information D1, and starts the installed watching auxiliary app 511 (FIG. 4). Meanwhile, the watching auxiliary app 511 may be configured to be embedded in advance. In this embodiment, the QR cord 511 is configured to be written on the ticket TC for watching soccer. Instead, the QR cord may be configured to be sticked onto each seat in a stadium in advance. That is, a configuration can also be adopted in which a QR cord having the seat information D2 corresponding to each seat is sticked onto each seat.

### A-4. Processing Using Watching Auxiliary App

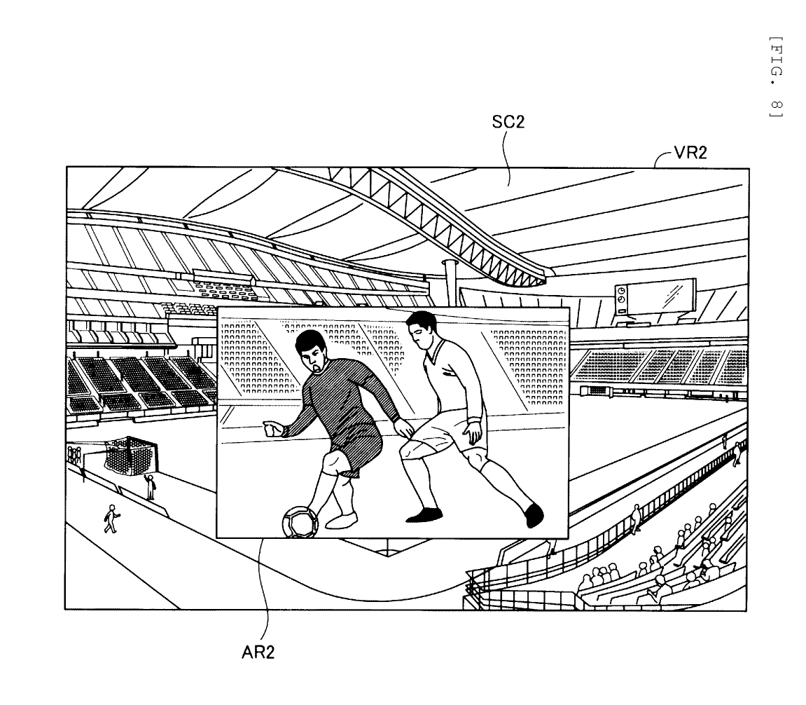

FIG. 7 is a flow chart illustrating details of a watching auxiliary routine. The watching auxiliary routine, which is a processing routine based on the watching auxiliary app 511, is executed by the CPU 140 of the HMD 100. The watching auxiliary routine is started to be executed by receiving the starting of the watching auxiliary app 511. Meanwhile, after the watching auxiliary app 511 is once installed in the HMD 100, the watching auxiliary routine can be started to be executed by directly giving an instruction for execution to the watching auxiliary app 511 rather than from the ticket TC.

When processing is started, the CPU 140 first stores the above-mentioned coded seat information D2 obtained by reading the QR cord 511 in a predetermined area of the storage unit 120 (FIG. 2) (step S110). Meanwhile, when the QR cord C3 is not read in starting the watching auxiliary app 511, the seat information D2 may be input using the touch pad 14 or the cross key 16.

Subsequently, the CPU 140 determines whether or not a seat determined by the seat information D2 is included in an upper-stage area of a stadium (step S120). The upper-stage area is an area which is set on the upper stage side in the stadium in advance. In this embodiment, it is determined in step S120 whether a seat is included in the upper-stage area so that a special service can be provided to audience included in the upper-stage area. In step S120, when it is determined that the seat determined by the seat information D2 is not included in the upper-stage area, the CPU 140 terminates the watching auxiliary routine.

On the other hand, when it is determined in step S120 that the seat determined by the seat information D2 is included in the upper-stage area, the CPU 140 detects the present position of the HMD 100 using the GPS module 134 (step S140), and determines whether or not the present position is located within the stadium where a soccer game is performed (step S150). Here, when it is determined that the present position is located in the stadium, the CPU 140 turns on a telescopic function of the external scenery image capturing camera 61 to thereby start image capturing (step S160). Meanwhile, during the image capturing, a captured moving image is stored in the storage unit 120 (step S170). In addition, during the image capturing, the processes of step S140 and step S150 are repeatedly performed, and the image capturing is continuously performed by step S160 and step S170 when it is determined in step S150 that the present position of the HMD 100 is located in the stadium.

As described above, the external scenery image capturing camera 61 can capture an image of external scenery in a direction in which a user faces. For this reason, according to the HMD 100, it is possible to automatically telephotograph the state of a game in a direction in which the user faces. Meanwhile, the HMD 100 can reproduce captured contents, that is, the captured moving image stored in the storage unit 120 using a reproduction application which is provided separately, in the middle of the telephotographing.

FIG. 8 is a diagram illustrating an example of information which is visually recognized by a user when a captured moving image is reproduced. FIG. 8 illustrates a user's visual field VR2. As illustrated in the drawing, the visual field VR2 includes an external scenery SC2 in a stadium. In addition, a reproduction region AR2 is displayed so as to be superimposed on the external scenery SC2. The reproduction region AR2 includes a captured moving image captured in the telescopic mode mentioned above.

When it is determined in step S150 of FIG. 7 that the present position of the HMD 100 is not located in the stadium, that is, that the HMD 100 moves to the outside of the stadium, the CPU 140 proceeds to the process of step S130 to delete the captured moving image stored in the storage unit 120 in step S170. Thereafter, the CPU 140 terminates the watching auxiliary routine.

Meanwhile, the processes of step S110 and step S120 in the watching auxiliary routine correspond to a use environment determination unit (FIG. 2), and the processes of step S160 and step S170 correspond to a processing control unit (FIG. 2).

According to the HMD 100 of the first embodiment which is configured as described above, when a use environment in a stadium lies in a seat environment of an upper-stage area, a state in a direction in which a user faces is automatically captured in a telescopic mode. For this reason, the user can view again a captured moving image which is automatically telephotographed and stored by reproducing the image in the cases such as “not being able to see” and “desiring to see this play again” because of being located at an upper stage. Therefore, according to the HMD 100, it is possible to easily implement a photographing function suitable for a seat environment of an upper-stage area. In addition, it is possible to improve user convenience in a seat environment of an upper-stage area. In addition, a captured image is deleted in the case of going out of the stadium, and thus it is possible to prevent a captured image from being carried out of the stadium.

As a modification example of the first embodiment described above, when it is determined that the HMD 100 has moved to the outside of a stadium, a configuration in which the reproduction of a captured moving image is locked may be adopted, instead of a configuration in which a captured moving image is deleted. Locking is performed outside the stadium, and thus it is possible to prohibit the above-mentioned captured moving image from being reproduced outside the stadium, and to reproduce a captured moving image in the past at the time of returning to the stadium. In addition, as another modification example of the first embodiment, a configuration in which the processes of step S110 and step S120 are deleted in FIG. 7 may be adopted. According to this modification example, telephotographing can be performed at any position in a stadium, and the captured image thereof is deleted at the time of moving to the outside of the stadium. Also in this modification example, a configuration in which the reproduction of a captured moving image is locked may be adopted, instead of a configuration in which a captured moving image is deleted.

### B. Second Embodiment

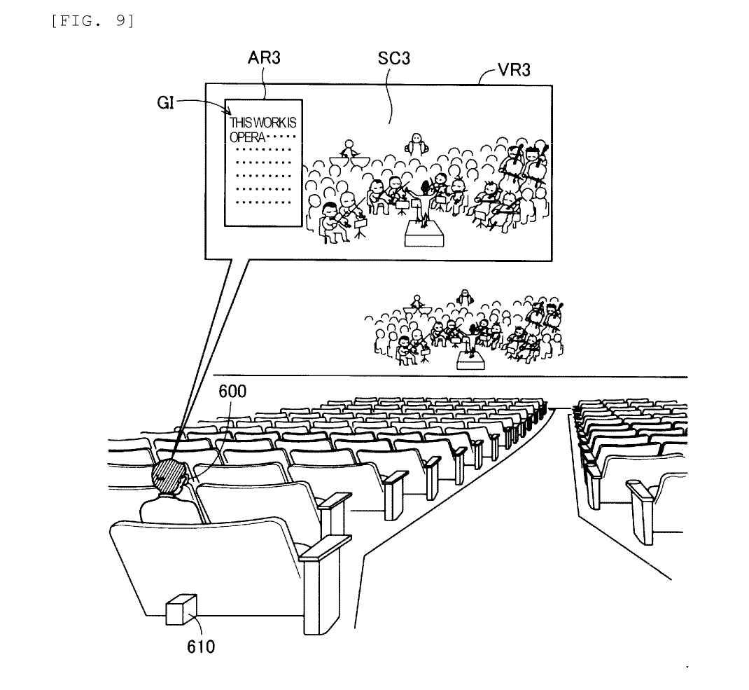

FIG. 9 is a diagram illustrating a using mode of an HMD according to a second embodiment of the invention. An HMD 600 according to the second embodiment is different from the HMD 100 according to the first embodiment in that the HMD includes an opera appreciation auxiliary app, and both the embodiments are the same as each other in the other respects. Meanwhile, a description will be given below by denoting parts that are the same as those in the first embodiment by the reference numerals and signs that are used in the first embodiment. As illustrated in the drawing, the HMD 600 according to the second embodiment is used inside a theater where opera is performed. The opera appreciation auxiliary app is downloaded, for example, from a home page of a theater to be used and is installed in the HMD 600 in advance.

A BLE terminal 610 is disposed at the back of a rearmost seat in the theater, and a signal of iBeacon is output from the BLE terminal 610. The signal of iBeacon stores at least a distance to the BLE terminal 610. When a user wearing the HMD 600 enters the theater, the user first starts an opera appreciation auxiliary app.

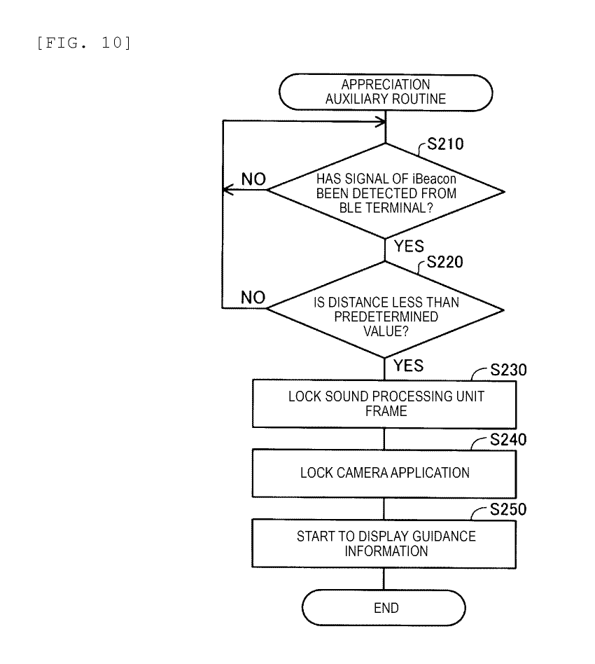

FIG. 10 is a flow chart illustrating details of an appreciation auxiliary routine. The appreciation auxiliary routine, which is a processing routine based on an opera appreciation auxiliary app, is executed by a CPU 140 of the HMD 600. In the appreciation auxiliary routine, an iBeacon processing unit 172 (FIG. 2) is used.

When processing is started, the CPU of the HMD 600 first determines whether or not a signal of iBeacon has been detected from a BLE terminal 670 (step S210). The CPU 140 repeatedly performs the process of step S210 until the signal of iBeacon is detected, and determines whether or not the distance stored in the detected signal is less than a predetermined value (for example, 7 m) when it is determined in step S210 that the signal has been detected (step S220). The determination of whether or not the distance is less than the predetermined value is performed to determine whether or not a seat of a user wearing the HMD 600 is included in a predetermined range on the back side of a theater. That is, the determination of whether or not the distance is less than the predetermined value includes the determination of whether or not a use environment of the HMD 600 lies in a seat environment of a rear seat. Here, when it is determined that the distance is not less than the predetermined value, the CPU 140 returns the process to step S210.

When it is determined in step S220 that the distance is less than the predetermined value, the CPU 140 locks a sound processing unit frame 523 and a camera app 513 that are included in an application layer 510 (FIG. 4) on the assumption that a use environment of the HMD 600 has transitioned to an environment of a rear seat (step S230 and step S240). Since the sound processing unit frame 523 takes charge of the whole output of a sound from the HMD 600, the output of a sound from the HMD 600 is wholly canceled (muted) by the sound processing unit frame 523 being locked.

On the other hand, a photographing function using the external scenery image capturing camera 61 is also included in marker recognition processing (processing of recognizing a QR cord in the first embodiment, and the like) using another app included in the application layer 510, in addition to a camera app 516. In this embodiment, image capturing using the camera app 516 is prohibited, and image capturing according to the marker recognition processing is not prohibited (that is, is permitted). That is, in this embodiment, image capturing using the camera app 516 that can be used for the purpose of surreptitious photographing is prohibited, and image capturing according to the marker recognition processing that cannot be used as surreptitious photographing is permitted. Meanwhile, as a modification example, image capturing may be completely prohibited by locking a camera library 536 included in a library layer 530.

After step S240 is performed, the CPU 140 is started to display guidance information (step S250). That is, the CPU 140 is started to display guidance information an image display unit 20. As illustrated in FIG. 9, a user's visual field VR3 includes an external scenery SC3 inside a theater, and a guidance information display region AR3 is displayed so as to be superimposed on the external scenery SC3. The guidance information display region AR3 includes guidance information GI. The guidance information GI is detailed information such as a technique, a historical background, and highlights of opera (performance work) which is performed. In this embodiment, the HMD 600 detects the start of a performance from a start time, and sequentially changes the pieces of guidance information included in the guidance information display region AR3 in accordance with a performance time. In this embodiment, a configuration has been adopted in which the guidance information display region AR3 is disposed at a position which is shifted from the center in the visual field VR3. Thereby, a user can view the guidance information GI without hindering the visual recognition of predetermined contents. Although the appreciation auxiliary routine is terminated after step S250 is performed, the started display of guidance information is continued until the performance is terminated.

Meanwhile, the processes of step S210 and step S220 in the appreciation auxiliary routine correspond to a use environment determination unit, and the processes of step S230 to step S250 correspond to a processing control unit. As the processing control unit, a configuration in which only any one of the processes of step S230 to step S250 is performed may be adopted, or a configuration in which any two of them are performed may be adopted, instead of a configuration in which all of the processes of step S230 to step S250 are performed.

According to the HMD 600 of the second embodiment which is configured as described above, when a use environment in a theater lies in a seat environment of a rear seat, it is possible to view guidance information of opera which is being performed, together with performance contents that are visually recognized as the external scenery SC3. In the seat environment of a rear seat in a theater (particularly, a large-scale theater), a target to be visually recognized is far away, and thus the proportion of the target in a visual field VR becomes smaller. For this reason, it is possible to sufficiently take a space for only displaying guidance information GI in the visual field VR. Therefore, according to the HMD 600, it is possible to easily implement a display function suitable for the seat environment of a rear seat. In addition, it is possible to improve user convenience in the seat environment of a rear seat.

### C. Third Embodiment

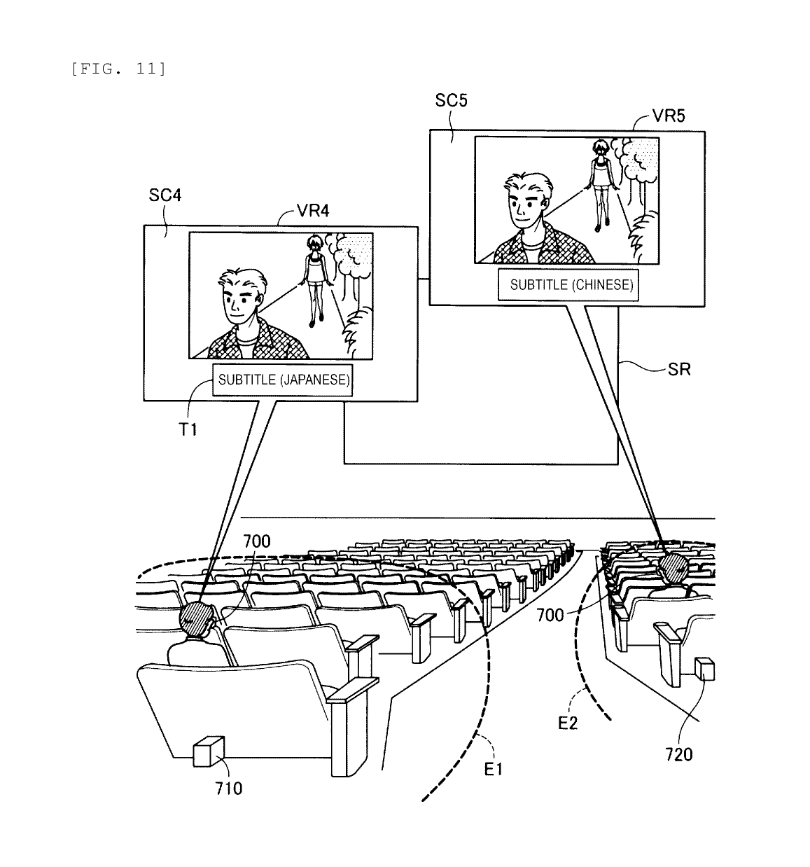

FIG. 11 is a diagram illustrating a using mode of an HMD according to a third embodiment of the invention. An HMD 700 according to the third embodiment is different from the HMD 100 according to the first embodiment in that the HMD includes a movie appreciation auxiliary app, and both the embodiments are the same as each other in the other respects. Meanwhile, a description will be given below by denoting parts that are the same as those in the first embodiment by the reference numerals and signs that are used in the first embodiment. As illustrated in the drawing, the HMD 700 according to the third embodiment is used in a movie theater. The movie appreciation auxiliary app is downloaded, for example, from a home page of a movie theater to be used and is installed in the HMD 700 in advance.

A first BLE terminal 710 is disposed at a first position in a movie theater, and a second BLE terminal 720 is disposed at a second position different from the first position in the movie theater. Signals of iBeacon are output from the BLE terminals 710 and 720, respectively. The signals of iBeacon include at least BLE terminal identification numbers form identifying the BLE terminals 710 and 720 and distances to the BLE terminals 710 and 720. When a user wearing the HMD 700 enters the movie theater, the user first starts a movie appreciation auxiliary app.

FIG. 12 is a flow chart illustrating details of an appreciation auxiliary routine. The appreciation auxiliary routine, which is a processing routine based on a movie appreciation auxiliary app, is executed by a CPU 140 of the HMD 700. In the appreciation auxiliary routine, an iBeacon processing unit 172 (FIG. 2) is used.

When processing is started, the CPU of the HMD 700 first determines whether or not a signal of iBeacon has been detected from at least one of the two BLE terminals 710 and 720 (step S310). The CPU 140 repeatedly performs the process of step S310 until the signal of iBeacon is detected, and determines whether or not the distance stored in the detected signal is less than a predetermined value (for example, 5 m) when it is determined in step S310 that the signal has been detected (step S320). Meanwhile, when a plurality of signals of iBeacon are detected, a signal having a short distance stored is regarded as the “detected signal”. The determination of whether or not the distance is less than the predetermined value is performed to determine whether or not a seat of a user searing the HMD 700 is included in either a first range E1 of which the radius is the predetermined value centering on a first position at which the first BLE terminal 710 is disposed or a second range E2 of which the radius is the predetermined value centering on a second position at which the second BLE terminal 720 is disposed. That is, the determination of whether or not the distance is less than the predetermined value includes the determination of whether or not a use environment of the HMD 700 is included in the first range E1 or the second range E2. Here, when it is determined that the distance is not less than the predetermined value, the CPU 140 returns the process to step S310.

When it is determined in step S320 that the distance is less than the predetermined value, the CPU 140 locks a sound processing unit frame 523 and a camera app 513 that are included in an application layer 510 (FIG. 4) on the assumption that a use environment of the HMD 700 has transitioned to an environment included in the first range E1 or the second range E2 (step S330 and step S340). The step S330 and step S340 are the same as step S230 and step S240 (FIG. 10) of the second embodiment.

After step S330 is performed, the CPU 140 is started to display subtitles of a language corresponding to the BLE terminal identification number stored in the detected signal (step S350). In this embodiment, subtitles are previously determined to be displayed in Japanese in the first range E1 in the movie theater and to be displayed in Chinese in the second range E2 in the movie theater. For this reason, in step S350, subtitles are started to be displayed in Japanese when the BLE terminal identification number stored in the detected signal indicates the first BLE terminal 710, and subtitles are started to be displayed in Chinese when the BLE terminal identification number stored in the detected signal indicates the second BLE terminal 720. Although the appreciation auxiliary routine is terminated after step S350 is performed, the started display of subtitles is continued until the showing is terminated.

Meanwhile, the processes of step S310 and step S320 in the appreciation auxiliary routine correspond to a use environment determination unit, and the processes of step S330 to step S350 correspond to a processing control unit. As the processing control unit, a configuration in which only any one of the processes of step S330 to step S350 is performed may be adopted, or a configuration in which any two of them are performed may be adopted, instead of a configuration in which all of the processes of step S330 to step S350 are performed.

According to the HMD 700 of the third embodiment which is configured as described above, when a use environment in a movie theater lies in a seat environment of the first range E1, it is possible to view Japanese subtitles together with a screen SR which is transmitted as an external scenery SC4 and is visually recognized. In addition, when a use environment in a movie theater is a seat environment of the second range E2, it is possible to view Chinese subtitles together with a screen SR which is transmitted as an external scenery SC5 and is visually recognized. Therefore, according to the HMD 700, it is possible to easily change a subtitle language in accordance with a seat environment. In addition, it is possible to improve user convenience in the seat environment.

### D. Fourth Embodiment

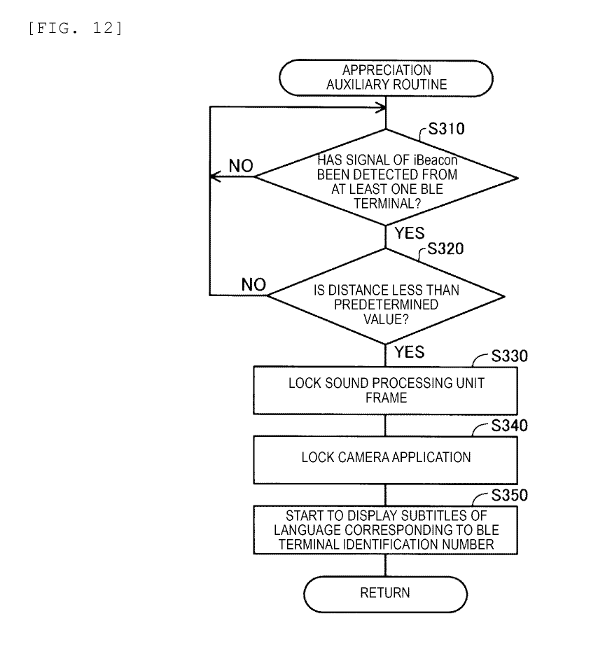

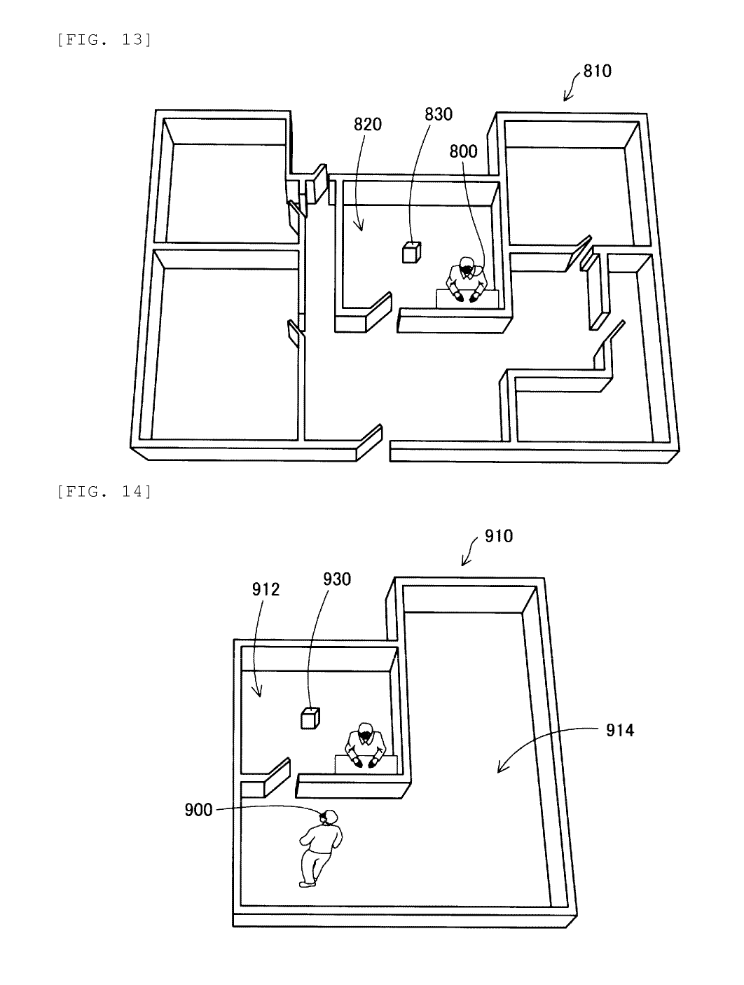

FIG. 13 is a diagram illustrating a using mode of an HMD according to a fourth embodiment of the invention. An HMD 800 according to the fourth embodiment is different from the HMD 100 according to the first embodiment in that the HMD includes an app execution restriction application, and both the embodiments are the same as each other in the other respects. The HMD 800 according to the fourth embodiment is used in an office 810 including a security room 820 that requires high-level security. A BLE terminal 830 is provided in the middle of the security room 820. When a distance between the BLE terminal 830 and the HMD 800 is set to be less than a predetermined value (for example, 5 m), a user wearing the HMD 800 is regarded as entering the security room 820. According to the app execution restriction application, when it is determined that a distance from the BLE terminal 830 is less than a predetermined value, the HMD 800 permits the execution of a predetermined application program and permits connection to a predetermined network. On the other hand, when it is determined that the distance from the BLE terminal 830 is equal to or greater than the predetermined value or when it is not possible to detect a signal of iBeacon from the BLE terminal 830, the execution of the predetermined application program is prohibited, and the connection to the predetermined network is prohibited.

According to the HMD 800 of the fourth embodiment which is configured as described above, the execution of a predetermined application and the connection to a predetermined network are permitted or prohibited according to whether or not a use environment lies in a security environment that requires high-level security. Therefore, according to the HMD 800, it is possible to easily switch between the permission and prohibition of execution of a predetermined application and between the permission and prohibition of connection to a predetermined network in accordance with a security environment. Meanwhile, in this embodiment, a configuration has been adopted in which both the execution of a predetermined application and the connection to a predetermined network are permitted or prohibited. Instead, a configuration may be adopted in which only one of the execution of a predetermined application and the connection to a predetermined network is performed.

### E. Fifth Embodiment

FIG. 14 is a diagram illustrating a using mode of an HMD according to a fifth embodiment of the invention. An HMD 900 according to the fifth embodiment is different from the HMD 100 according to the first embodiment in that the HMD includes a wireless communication restriction application, and both the embodiments are the same as each other in the other respects. The HMD 900 according to the fifth embodiment is used in a space in which wireless communication is required to be restricted (prohibited), for example, a hospital 910. Since there is a concern of wireless communication through Wi-Fi, a wireless LAN, or the like causing the erroneous operation of a medical instrument, the wireless communication is required to be restricted in a hospital.

The hospital 910 includes a consultation room 912 and a waiting room 914. ABLE terminal 930 is provided in the middle of the consultation room 912. When a distance between the BLE terminal 930 and the HMD 900 is set to be less than a predetermined value (for example, 5 m), a user wearing the HMD 900 is regarded as entering the consultation room 912 from the waiting room 914. According to the wireless communication restriction application, when the HMD 900 determines that the distance from the BLE terminal 930 is less than the predetermined value, a CPU prohibits connection to wireless communication through Wi-Fi, a wireless LAN, or the like. On the other hand, when it is determined that the distance from the BLE terminal 930 is equal to or greater than the predetermined value or when it is not possible to detect a signal of iBeacon from the BLE terminal 930, the CPU permits the connection to wireless communication.

According to the HMD 900 of the fifth embodiment which is configured as described above, the connection to wireless communication through Wi-Fi, a wireless LAN, or the like is prohibited when a use environment is an environment where wireless communication is required to be restricted, and the connection to wireless communication is permitted when a use environment is not the above-mentioned environment. Therefore, according to the HMD 900, it is possible to easily switch between the permission and prohibition of connection to wireless communication in accordance with a use environment.

### F. Sixth Embodiment

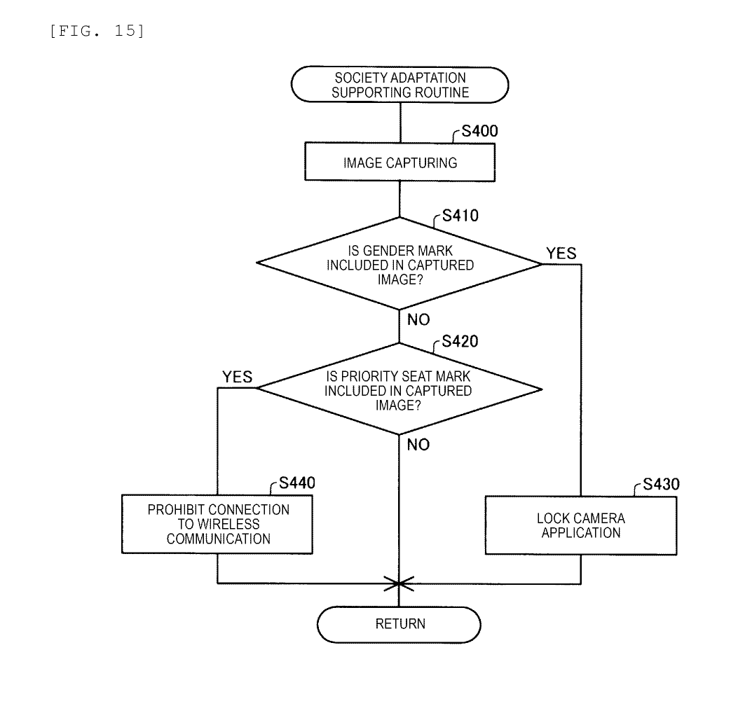

FIG. 15 is a flow chart illustrating a society adaptation supporting routine which is executed by an HMD according to a sixth embodiment of the invention. The society adaptation supporting routine is a program which is developed for the purpose of adapting the HMD to society. The HMD according to the sixth embodiment is different from the HMD 100 according to the first embodiment in that the society adaptation supporting routine is executed by a CPU, and both the embodiments are the same as each other in the other respects. The society adaptation supporting routine is repeatedly executed by interruption for each predetermined time after the HMD is started.

When processing is started, the CPU of the HMD first performs image capturing using an external scenery image capturing camera 61 (step S400), and determines whether or not a gender mark in a public toilet is included in an obtained captured image (step S410). In addition, the CPU determines whether or not a priority seat mark is included in an obtained captured image (step S420).

FIG. 16 is a diagram illustrating a public toilet 1010. A gender mark 1020 is attached in the vicinity of an entrance of the public toilet 1010, as a sign for indicating the public toilet.

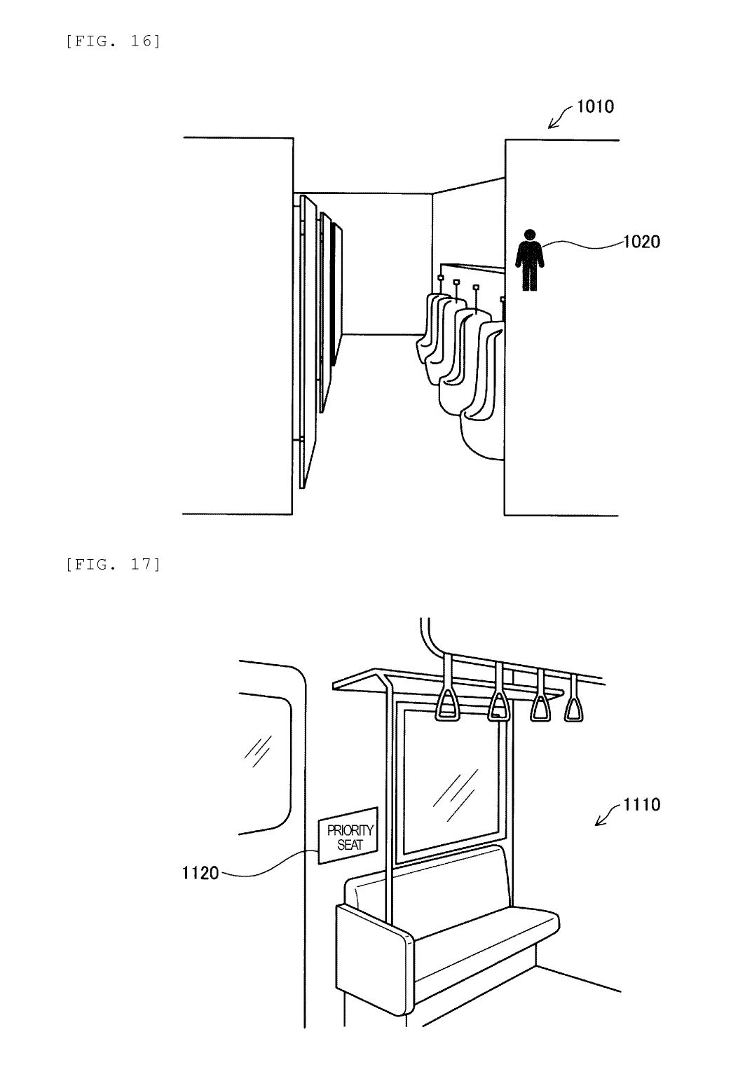

FIG. 17 is a diagram illustrating a priority seat 1110 in a train. A priority seat mark 1120 is attached in the vicinity of the priority seat 1110, as a sign for indicating the priority seat.

Image patterns for a large number of markers indicating public spaces are stored in a storage unit of the HMD in advance. In step S410 of FIG. 15, it is determined whether or not a gender mark in a public toilet as a marker is included in a captured image through image pattern recognition using the image pattern. In step S420, it is determined whether or not a priority seat mark as a marker is included in a captured image through image pattern recognition.

When it is determined in step S410 of FIG. 15 that the gender mark in the public toilet is included in the captured image, the CPU locks a camera app (step S430). The process of step S430 is the same as the process of step S240 (FIG. 10) in the second embodiment. Image capturing using a camera app 516 is prohibited, and image capturing according to marker recognition processing is not prohibited. That is, in step S430, image capturing using the camera app 516 that can be used for the purpose of surreptitious photographing is prohibited, and image capturing according to marker recognition processing that cannot be used as surreptitious photographing is permitted. After step S430 is performed, the society adaptation supporting routine is temporarily terminated.

When it is determined in step S420 that the priority seat mark is included in the captured image, the CPU prohibits the connection to wireless communication through Wi-Fi, a wireless LAN, or the like (step S440). After step S440 is performed, the society adaptation supporting routine is temporarily terminated.

When it is determined in step S410 that the gender mark in the public toilet is not included and it is determined in step S420 that the priority seat mark is not included, the society adaptation supporting routine is temporarily terminated as it is.

Meanwhile, when the camera app is locked in step S430 or when the connection to wireless communication is prohibited in step S440, a predetermined range based on a point at which it is determined that the gender mark or the priority seat mark is included is set as an application area. When the movement of the HMD to the outside of the application area is detected by a GPS module 134, restriction by step S430 or step S440 is canceled.

According to the HMD of the sixth embodiment which is configured as described above, it is possible to prohibit image capturing using the camera app 516 in a public toilet and to prohibit the connection to wireless communication through Wi-Fi, a wireless LAN, or the like in the vicinity of a priority seat in a train.

Although a public toilet and a priority seat are illustrated as public spaces in the sixth embodiment, it is also possible to apply this embodiment to various public spaces such as a hospital, the inside of an airplane, a restaurant, a movie theater, a school, a library, and a museum. For the purpose of detecting transition to a public space, in this embodiment, it is determined whether or not a marker indicating the public space is included in a captured image. However, a use environment may also be determined on the basis of a signal from a wireless communication terminal such as iBeacon (registered trademark). In addition, transition to a public space may be detected on the basis of light information such as an LED or an electric bulb, sound detection position information, GPS information, and the like.

### G. Seventh Embodiment

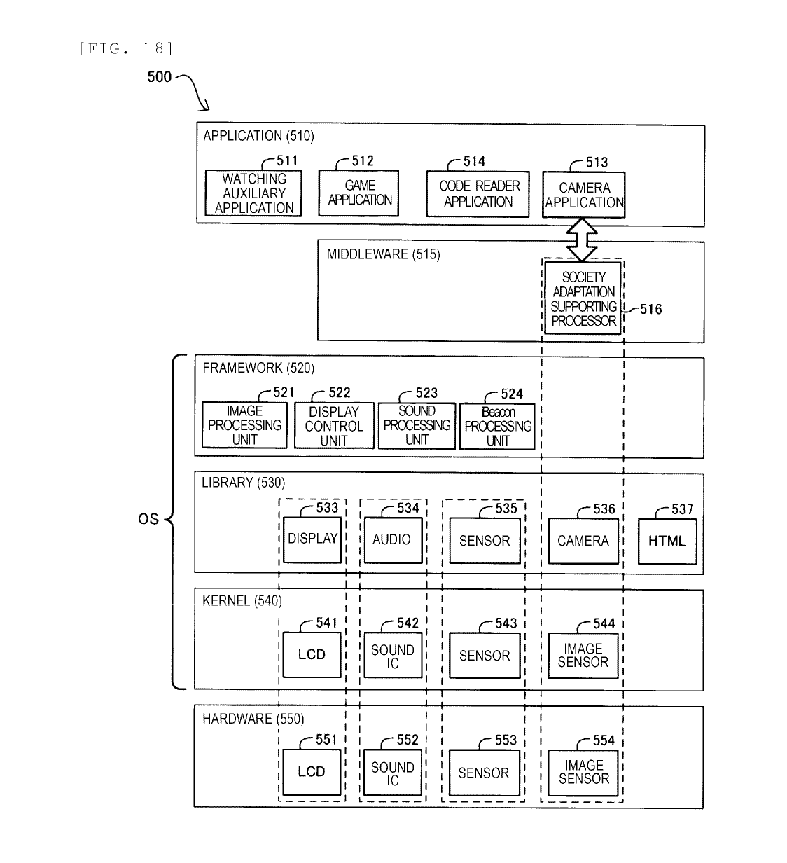

FIG. 18 is a diagram illustrating a platform of an HMD according to a seventh embodiment of the invention. This drawing is the same as FIG. 4 in the first embodiment. FIG. 18 is different from FIG. 4 in that the platform of the HMD according to the seventh embodiment includes a middleware 515. The middleware 515 includes a society adaptation supporting processor 516. The society adaptation supporting processor 516 executes the society adaptation supporting routine (FIG. 15) in the sixth embodiment. That is, the HMD according to this embodiment includes the society adaptation supporting processor 516 that executes society adaptation supporting routine, as middleware. The society adaptation supporting processor 516 is a subordinate concept of a “device control unit” included in a configuration of the invention.

An image sensor device 554 is a device operable using a camera app 513 which is locked by step S430 of the society adaptation supporting routine (FIG. 15). That is, the image sensor device 554, an image sensor driver 544, and a camera library 536 have a correspondence, and thus operate in cooperation with each other. Particularly, in this embodiment, the image sensor device 554 is configured to be driven by only the image sensor driver 544 and the camera library 536 and is configured not to be driven by other drivers and libraries. In addition, the image sensor driver 544 and the camera library 536 is configured to be exclusively usable by the society adaptation supporting processor 516. That is, the image sensor driver 544 and the camera library 536 are configured to be unusable without using the society adaptation supporting processor 516.

The camera app 513 can use the image sensor device 554 as a hardware resource through the society adaptation supporting processor 516. In other words, the only application capable using the image sensor device 554 without going through the society adaptation supporting processor 516 is the camera app 513.

According to the HMD of the seventh embodiment which is configured as described above, similarly to the sixth embodiment, it is possible to prohibit image capturing using the camera app 516 in a public toilet and to prohibit the connection to wireless communication through Wi-Fi, a wireless LAN, or the like in the vicinity of a priority seat in a train. As a result, it is possible to adapt the HMD to society. In this embodiment, when the society adaptation supporting processor 516 is not used, image capturing using the image sensor device 554 cannot be performed. Accordingly, the opening of the specification of the society adaptation supporting processor 516 is restricted, and thus it is possible to capture an image of external scenery using only a specific camera app 513 which is developed by a person to which the specification is opened. For example, a mark guaranteeing adaptation to society is attached to an HMD equipped with the camera app 513, and thus a person around a person wearing the HMD can safely live. Therefore, it is possible to further adapt the HMD to society.

Meanwhile, in this embodiment, a configuration in which the society adaptation supporting processor 516 exclusively uses the image sensor driver 544 and the camera library 536 has been adopted, but a configuration in which the society adaptation supporting processor exclusively uses a wireless communication module such as Wi-Fi or a wireless LAN may be adopted.

### H. Modification Example

Meanwhile, the invention is not limited to the first to fourth embodiments described above and modification examples thereof, and can be implemented in various modes without departing from the scope of the invention. For example, the following modifications can be made.

### H-1. Modification Example 1

A difference in use environment is as follows.

[1] Geographical differences such as a country, a state, a prefecture, a city, and an administrative district.
[2] The inside or outside of a specific institution, for example, a stadium, a theater, an art museum, a museum, a movie theater, a concert hall, an institute, a company, a department store, a factory, a school, a hospital, an expressway, a sports stadium, a construction site, a zoo, a botanic garden, or a park. In this case, the determination of distinguishment between the inside and the outside may be performed for stadiums and theaters. Determination may be performed with a specific institution such as XX art museum as a target.
[3] The inside or outside of a specific area, for example, a sand dune, a bog, a beach, or a mountain range. In this case, the determination of distinguishment between the inside and the outside may be performed for sand dunes and bogs. Determination may be performed with a specific institution such as XX bog as a target.
[4] the inside or outside of a specific transportation means, for example, an airplane, a train, a ship, or a vehicle. In this case, the determination of distinguishment between the inside and the outside may be performed for airplanes and trains. Determination may be performed with specific transportation means as a target.
[5] A specific position on the inner side of each of [2] to [4] mentioned above. For example, the first to fourth embodiments applies to this case.
[6] A difference in an element, for example, illumination intensity, temperature, humidity, a noise level, and an environment sound, smell, an air volume, a wind direction, snow, or rain, which is felt in user's five senses (the sense of sight, the sense of hearing, the sense of smell, the sense of taste, and the sense of touch) at a place where the user is located may be recognized as a difference in use environment. A difference in use environment may be recognized by an environmental element, for example, a low-frequency sound, the amount of infrared rays, the amount of ultraviolet rays, a radio wave strength, or a magnetic field strength, which is not felt in the five senses.
[7] A difference in use environment may be distinguished in advance by a statistical or nonstatistical method. For example, the difference may be distinguished by a difference in safety (can be indexed by a crime rate, an accident rate, a damage rate, or the like) in a place where a user is located, a difference in convenience (can be indexed by a distance to a station, the number of convenience stores, a distance to a school, or the like), and a difference in sociality (public space, a private space, or the intermediate space therebetween). Such distinguishment may be indexed in advance to be associated with positional information, or may be acquired every time through a network such as the Internet.

Specifically, the prevention of surreptitious photographing may be achieved by adopting a configuration in which a camera app 516 is locked when transition to a public space such as, for example, the inside of a train, the inside of a car, and the inside of an airplane is detected. For example, when movement to a company is detected, the execution of an application program for business use may be permitted. For example, under an environment such as the inside of an airplane, a configuration may be adopted in which the use of a mobile phone and a wireless LAN as the base of a disturbing radio wave is prohibited and Bluetooth and iBeacon less affecting an electronic device in an airplane can be used. For example, when a use environment of an HMD being a specific country is detected by a GPS or the like, a function determined in accordance with the country may be changed. For example, it is possible to change a use language in an HMD, to change use units such as length and mass which are displayed in an HMD, and to change the output restriction of a wireless device of an HMD.

### H-2. Modification Example 2

Determination of a use environment is as follows.

### [1] Determination Based on Captured Image

<1> Method of directly performing determination from captured external scenery. For example, a landscape, scenery, and the external shape of a building are determined using imaging matching.
<2> Method of performing determination using marker included in captured external scenery. The marker includes a bar code, QR cord (registered trademark), a signboard having a specific form, a specific sign (for example, signs such as “image capturing prohibited” and “flash prohibited”), a mark, a character string, and the like. In addition, the marker may be a fixed object (signboard, a road surface mark, or the like) in land or an institution, or may be a marker (placard, a poster, or the like) which can be easily installed or carried.
<3> Determination not only from external scenery but also from specific captured image such as endoscope image in operation. Method of performing determination using marker included in specific captured image.

### [2] Determination Using Recorded Sound.

<1> Determination of beach, town, or the like by analyzing sound
<2> Determination based on specific pattern included in sound. Music which is being played, beacon of audible band, and the like.
[3] Determination based on signal such as radio wave or magnetic field. For example, wireless LAN, Bluetooth, and iBeacon.

### H-3. Modification Example 3

A predetermined function modified is as follows.

### [1] Photographing Function

A function of capturing a still image may be used instead of a function of capturing a moving image as described in the first embodiment. In addition, a telephotographing function may be used as described in the first embodiment, or various types of photographing functions such as an infrared photographing function and a panoramic photographing function may be used. In the first embodiment described above, switching between turn-on and turn-off of driving is performed as a modification of a photographing function using a camera. Instead, change in resolution, switching between turn-on and turn-off of infrared photographing, switching between turn-on and turn-off of a video function, switching between color and monochrome, switching between turn-on and turn-off of consecutive photographing, switching between turn-on and turn-off of split photographing, the switching of a storage format (raw data), switching between possibility and impossibility of the storage of a captured image, the switching of the application of a password for a captured image, and switching between various filter photographing operations may be performed. That is, in addition to the turn-on and turn-off of a photographing function, the photographing function may be partially stopped and may be partially activated. For example, when transition to a public space is detected, the resolution of a camera may be restricted. For example, the function of a camera that usually has 12 million pixels may be lowered so as to have a function of 300,000 pixels which is a level at which the face of a person cannot be recognized.

### [2] Sound Recording Function

Instead of a recording function as described in the first embodiment, a sound recording function may be used. For example, in a use environment of a concert hall, a sound recording function may be prohibited. In addition, as a modification of the sound recording function, switching between turn-on and turn-off of a microphone, switching between turn-on and turn-off of the sound recording function itself, switching between storage and non-storage of a sound recording sound, switching between application and non-application of a password, and the like may be performed.

### [3] Sound Function

In the second and third embodiments described above, as a processing control unit, the sound processing unit frame 523 is locked to suppress the use of a sound function. Instead, a configuration in which an output level of a sound is suppressed (that is, a sound volume is lowered) may be adopted. For example, a configuration in which the degree of a sound output is promoted (that is, a sound volume is increased) may be adopted. That is, in addition to the turn-on and turn-off of a photographing function, the photographing function may be partially stopped and may be partially activated. In addition, a modification of the sound function can be applied to various switching operations such as a change in register, a change in bit rate (AM broadcasting wave, high quality, and the like), switching between turn-on and turn-off of Dolby, changes in the number and types of usable sound sources (synthesizer, sound synthesis), switching between stereo and monaural, and switching between either a right side or a left side and both right and left sides.

### [4] Information Instructing Function

As an information presentation function, guidance information is displayed in the second embodiment described above, subtitles are displayed in the third embodiment described above, and switching between whether to perform the display and whether not to perform the display is performed. Instead, a configuration in which a display ability is changed may be adopted. For example, switching between a binocular display using the right display driving portion 22 and the left display driving portion 24 and a monocular display using any one of them, a change in resolution, switching between a 3D display and a 2D display, switching between color and monochrome, a change in transmittance, a change in display luminance, a change in the number of moving image frames, a change in display language, and the like may be performed. In addition, switching between turn-on and turn-off of an advertisement display may be performed. In addition, as a configuration in which the information presentation function is suppressed, a configuration in which the use of a predetermined function is suppressed, such as a configuration in which the amount of guidance information to be displayed is reduced, may be adopted. In addition, for example, a configuration in which the use of the information presentation function is promoted, such as a configuration in which the amount of guidance information to be displayed is increased, may be adopted.

[5] Modification of Function of Associating HMD with the Outside

For example, as a modification of a communication function, switching between turn-on and turn-off of the communication function, a change in communication speed, a change in communication distance, a change in the range of a connection destination network, switching between possibility and impossibility of automatic connection, and the like may be performed. In addition, switching between turn-on and turn-off of Bluetooth or iBeacon, switching between possibility and impossibility of the multi-link of Bluetooth, switching between turn-on and turn-off of an RF tag reading function, a change in the access range of a memory, switching between possibility and impossibility of access to an external memory, a change in the access range of a library or a driver, and the like may be performed. In addition, switching between turn-on and turn-off of various sensors may be performed.

A predetermined function to be modified includes various functions other than [1] to [5] mentioned above. In addition, a modification of a function includes turn-on, turn-off, suppression, promotion, partial stop, and partial activation. Further, a modification of a function also includes the addition and removal of a function, and the like.

### H-4. Modification Example 4

In the above-described embodiments, as a method of modifying a function, an element (for example, the camera app 516) which is included in the application layer 510 is changed, and an element (for example, the sound processing unit frame 523) which is included in the framework layer 520 is changed. Instead, an element included in the library layer 530 may be changed, an element included in the kernel layer 540 may be changed, or an element included in the hardware layer 550 may be changed.

### H-5. Modification Example 5

In the above-described embodiments, a use environment of an HMD is a use environment which is changed by the movement of the HMD. Instead, a use environment which is changed by a change in the vicinity of the HMD, regardless of the movement of the HMD, may be used. For example, the transition of seasons may be detected, and display luminance based on the image display unit 20 in summer may be increased more than that in winter.

### H-6. Modification Example 6

In the seventh embodiment described above, a configuration in which an application capable of using the image sensor device 554 is restricted by the society adaptation supporting processor 516 has been adopted. On the other hand, as a modification example, a configuration may be adopted in which an external scenery image capturing camera is provided with a rotary type or slide type lens cover mechanism is provided, a lens cover is openable and closable, and an application capable of using the lens cover mechanism is restricted by the society adaptation supporting processor. According to this modification example, it is possible to determine whether or not the external scenery image capturing camera 61 is operating by confirming the opening or closing of the lens cover when viewed from the outside, and thus surrounding people can safely live, and an HMD equipped with the society adaptation supporting processor guarantees the safe living of the surrounding people.

### H-7. Modification Example 7

In the seventh embodiment described above and the modification example thereof, as a modification function in a public space, a configuration has been adopted in which image capturing using the external scenery image capturing camera 61 and wireless communication through Wi-Fi, a wireless LAN, or the like are prohibited. On the other hand, as a modification example, a configuration may be adopted in which image capturing restriction for performing image capturing by blurring a face portion is performed. Further, a configuration may be adopted in which acquisition related to the authentication of an organism such as a fingerprint or an iris, in addition to a face, is prohibited. In addition, as the modification function in a public space, [1] Photographing Function, [2] Sound Recording Function, [3] Sound Function, [4] Information Instructing Function, and [5] Function of Associating HMD with the Outside which are described above can also be used.

### H-8. Other Modification Examples

In the above-described embodiments, a configuration of a head mounted display has been exemplified. However, any configuration of the head mounted display may be defined without departing from the scope of the invention, and, for example, each component may be added, deleted, changed, or the like.

In the above-described embodiments, the allocation of the constituent elements to the control unit and the image display unit are merely an example, and may adopt various aspects. For example, the following aspects may be adopted: (i) an aspect in which a processing function such as a CPU and a memory is mounted in the control unit, and only a display function is mounted in the image display unit, (ii) an aspect in which a processing function such as a CPU and a memory is mounted in both the control unit and the image display unit, (iii) an aspect in which the control unit and the image display unit are integrally formed (for example, an aspect in which the image display unit includes the control unit and functions as a spectacles type wearable computer), (iv) an aspect in which a smartphone or a portable game machine is used instead of the control unit, and (v) an aspect in which the control unit and the image display unit are configured to communicate with each other and to be supplied with power in a wireless manner to thereby remove the connection unit (codes).

In the above-described embodiments, for convenience of description, the control unit includes the transmission unit, and the image display unit includes the reception unit. However, both the transmission unit and the reception unit of the above-described embodiment have a bidirectional communication function, and thus can function as a transmission and reception unit. In addition, for example, the control unit illustrated in FIG. 2 is connected to the image display unit through a wired signal transmission path. However, the control unit and the image display unit may be connected to each other through a wireless signal transmission path such as a wireless LAN, infrared communication, or Bluetooth (registered trademark).

For example, configurations of the control unit and the image display unit described in the above-described embodiments may be arbitrarily changed. Specifically, for example, a configuration may be adopted in which the touch pad is removed from the control unit and operation is performed using only the cross key. In addition, the control unit may include another operation interface such as an operation stick. In addition, the control unit may be configured to be connected to a device such as a keyboard or a mouse to thereby receive an input from the keyboard or the mouse. In addition, for example, not only an operation input using the touch pad or the cross key but also an operation input using a foot switch (switch operated by a user's foot) may be acquired. For example, the image display unit may be provided with an eye gaze detection unit such as an infrared sensor to detect the user's eye gaze, and an operation input according to a command associated with the movement of the eye gaze may be acquired. For example, a user's gesture may be detected using a camera, and an operation input according to a command associated with the gesture may be acquired. When the gesture is detected, the user's fingertip, a ring worn on the user's finger, a medical equipment held in the user's hand, or the like can be used a mark for detecting movement. When an operation input using a foot switch or eye gaze can be acquired, the input information acquisition unit can acquire an operation input from the user even in an operation for which it is difficult for the user to release his or her hand.

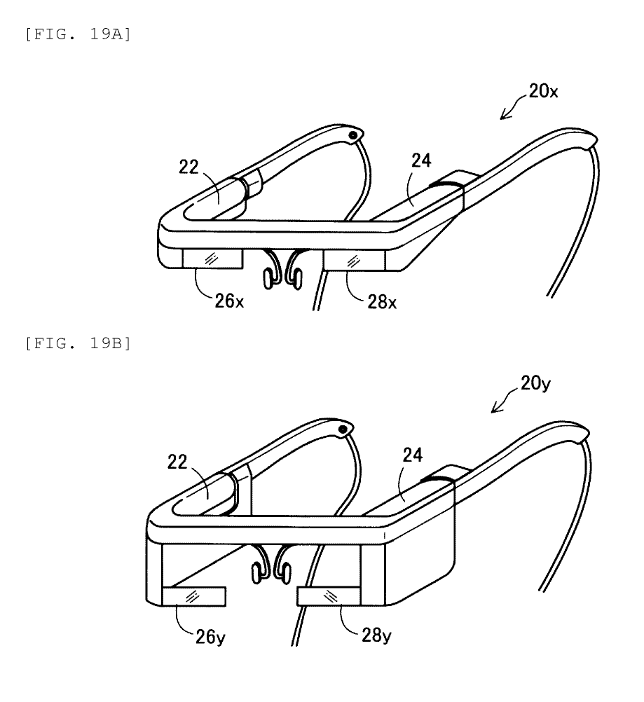

FIGS. 19A and 19B are diagrams illustrating exterior configurations of HMDs according to a modification example. In an example of FIG. 19A, an image display unit 20x includes a right optical image display portion 26x instead of the right optical image display portion 26, and include a left optical image display portion 28x instead of the left optical image display portion 28. The right optical image display portion 26x and the left optical image display portion 28x are formed to be smaller than the optical member in the above-described embodiments, and are disposed on the obliquely upper side of the right eye and the left eye of the user when the HMD is mounted. In an example of FIG. 19B, an image display unit 20y includes a right optical image display portion 26y instead of the right optical image display portion 26, and includes a left optical image display portion 28y instead of the left optical image display portion 28. The right optical image display portion 26y and the left optical image display portion 28y are formed to be smaller than the optical member in the above-described embodiments, and are disposed on the obliquely lower side of the right eye and the left eye of the user when the HMD is mounted. As described above, the optical image display portions have only to be disposed in the vicinity of the user's eyes. In addition, any size of the optical member forming the optical image display portions may be used, and the HMD may be implemented in an aspect in which the optical image display portions cover only a portion of the user's eyes, in other words, the optical image display portions do not completely cover the user's eyes.

For example, the head mounted display is a binocular transmission type head mounted display, but may be a monocular head mounted display. In addition, the head mounted display may be configured as a non-transmissive head mounted display through which external scenery is blocked from being transmitted in a state where the user wears the head mounted display.

For example, a description has been given that the function units such as the image processing unit, the display control unit, and the sound processing unit are implemented by the CPU developing a computer program stored in the ROM or the hard disk on the RAM and executing the program. However, these function units may be configured using an application specific integrated circuit (ASIC) which is designed for implementing the functions.

For example, in the above-described embodiments, the image display unit is configured as a head mounted display which is mounted like spectacles, but may be a normal flat display device (liquid crystal display device, a plasma display device, an organic EL display device, or the like). Also in this case, connection between the control unit and the image display unit may be connection through a wired signal transmission path, or may be connection through a wireless signal transmission path. Thereby, it is also possible to use the control unit as a remote controller of a normal flat display device.

In addition, as the image display unit, an image display unit having another shape such as an image display unit which is worn like, for example, a cap may be adopted instead of an image display unit which is worn like spectacles. In addition, an ear-mounted type or a head band type may be adopted as the earphone, or the earphone may be omitted. In addition, the image display unit may be configured as a head-up display (HUD) which is mounted in, for example, a vehicle such as an automobile or an airplane. In addition, the image display unit may be configured as a head mounted display built into a body protection tool such as, for example, a helmet.

For example, in the above-described embodiments, the display driving portion is configured using the backlight, the backlight control unit, the LCD, the LCD control unit, and the projection optical system. However, the above-described aspect is merely an example. The display driving portion may include a component for implementing other types together with these components or instead of these components. For example, the display driving portion may be configured to include an organic electro-luminescence (EL) display, an organic EL control unit, and a projection optical system. For example, the display driving portion may use a digital micro mirror device (DMD) or the like instead of the LCD. For example, the display driving portion may be configured to include a signal optical modulation unit, including color light sources for generating color light beams of RGB and a relay lens, a scan optical system including a MEMS mirror, and a driving control circuit that drives the unit and the system. In this manner, even when the organic EL, the DMD, and the MEMS mirror are used, an “emission region in a display driving portion” remains a region in which image light is actually emitted from the display driving portion, and an emission region in each device (display driving portion) is controlled in the same manner as in the above-described embodiments, and thus it is possible to obtain the same effects as in the above-described embodiments. In addition, for example, the display driving portion may be configured to include one or more lasers, having intensity according to a pixel signal, which are emitted toward a user's retinas. In this case, the “emission region in the display driving portion” refers to a region in which a laser beam indicating an image is actually emitted from the display driving portion. The emission region for the laser beam in the laser (display driving portion) is controlled in the same manner as in the above-described embodiments, and thus it is possible to obtain the same effects as in the above-described embodiments.

The invention is not limited to the above-described embodiments or modification examples, and may be implemented using various configurations within the scope without departing from the spirit thereof. For example, the embodiments corresponding to technical features of the respective aspects described in Summary and the technical features in the modification examples may be exchanged or combined as appropriate in order to solve some or all of the above-described problems, or in order to achieve some or all of the above-described effects. In addition, if the technical features are not described as essential features in this specification, the technical features may be deleted as appropriate.

### REFERENCE SIGNS LIST

10: Control unit (controller)
12: Lighting portion
14: Touch pad
16: Cross key
18: Power switch
20: Image display unit
21: Right holding portion
22: Right display driving portion
23: Left holding portion
24: Left display driving portion
26: Right optical image display portion
28: Left optical image display portion
30: Earphone plug
32: Right earphone
34: Left earphone
40: Connection unit
42: Right cord
44: Left cord
46: Connection member
48: Main cord
51: Transmission unit
52: Transmission unit
53: Reception unit
54: Reception unit
61: External scenery image capturing camera
100: Head mounted display device (HMD)
110: Input information acquisition unit
120: Storage unit
130: Power supply
132: Wireless communication unit
140: CPU
160: Image processing unit
162: Display control unit
164: Use environment determination unit
166: Processing control unit
170: Sound processing unit
180: Interface
201: Right backlight control unit
202: Left backlight control unit
211: Right LCD control unit
212: Left LCD control unit
221: Right backlight
222: Left backlight
241: Right LCD
242: Left LCD
251: Right projection optical system
252: Left projection optical system
261: Right light guide plate
262: Left light guide plate
500: Platform
510: Application layer
511: Watching auxiliary app
512: Game app
513: Camera app
514: Code reader app
516: Society adaptation supporting processor
520: Framework layer
530: Library layer
533: Display library
534: Audio library
535: Sensor library
536: Camera library
537: Library
540: Kernel layer
542: Sound IC driver
543: Sensor driver
544: Image sensor driver
550: Hardware layer
552: Sound IC device
553: Sensor device
554: Image sensor device
600,700,800,900: Head mounted display device (HMD)
610,710,720: BLE terminal
810: Office
820: Security room
830: BLE terminal
910: Hospital
912: Consultation room
914: Waiting room
930: BLE terminal
1010: Public toilet
1020: Gender mark
1110: Priority seat
1120: Priority seat mark

1. A head mounted display device which is a transmission type, the head mounted display device comprising:
an image display unit that displays an image to allow a user wearing the head mounted display device to visually recognize the image and is capable of transmitting external scenery;
a use environment determination unit that determines a use environment of the head mounted display device; and
a processing control unit that changes at least a portion of a predetermined function built into the head mounted display device in accordance with the determined use environment.

2. The head mounted display device according to claim 1, wherein the use environment is a use environment which is changed by movement of the head mounted display device.

3. The head mounted display device according to claim 1, further comprising:
an image capturing unit that performs image capturing,
wherein the use environment determination unit determines the use environment on the basis of a captured image obtained by the image capturing unit.

4. The head mounted display device according to claim 3, wherein when a marker for recognizing a specific use environment is included in the captured image obtained by the image capturing unit, the use environment determination unit determines the specific use environment.

5. The head mounted display device according to claim 1, wherein the use environment determination unit determines the use environment on the basis of a signal from an external wireless communication terminal.

6. The head mounted display device according to claim 1, wherein the predetermined function is a telephotographing function of performing telephotographing using a camera unit.

7. The head mounted display device according to claim 6,
wherein the use environment includes at least a specific seat environment in a sports stadium, and
wherein when the use environment determination unit determines the specific seat environment, the processing control unit turns on the telephotographing function to perform telephotographing using the camera unit.

8. The head mounted display device according to claim 7, further comprising an erasure unit that erases a captured image recorded through the telephotographing when movement of the head mounted display device to the outside of the sports stadium is detected.

9. The head mounted display device according to claim 1,
wherein when the use environment determination unit determines a predetermined use environment, the processing control unit acquires predetermined data and stores the data in a storage unit, and
wherein when the use environment determination unit determines separation from the predetermined use environment, the predetermined data stored in the storage unit in the predetermined use environment is erased.

10. The head mounted display device according to claim 1, wherein the predetermined function is an information presentation function of displaying predetermined information on the image display unit.

11. The head mounted display device according to claim 10,
wherein the use environment includes at least a specific seat environment in a theater, and
wherein when the use environment determination unit determines the specific seat environment, the processing control unit displays information regarding a performance work in the theater as the predetermined information.

12. The head mounted display device according to claim 10,
wherein the use environment includes at least a specific seat environment in a movie theater, and
wherein when the use environment determination unit determines the specific seat environment, the processing control unit displays subtitles as the predetermined information.

13. The head mounted display device according to claim 12,
wherein the specific seat environment in the movie theater includes a first coordinate environment and a second coordinate environment, and
wherein the processing control unit displays the subtitles written in a first language when the use environment determination unit determines the first seat environment, and displays the subtitles written in a second language different from the first language when the use environment determination unit determines the second seat environment.

14. The head mounted display device according to claim 1,
wherein the use environment includes at least a security environment requiring high level security, and
wherein the processing control unit permits execution of a predetermined application when the use environment determination unit determines the security environment, and prohibits execution of the predetermined application when the use environment determination unit determines not to be the security environment.

15. The head mounted display device according to claim 1, wherein the use environment is a public space.

16. The head mounted display device according to claim 15, wherein when the use environment determination unit determines the public space, the processing control unit prohibits image capturing using an image sensor device according to a predetermined application.

17. The head mounted display device according to claim 1, further comprising:
a storage unit that stores an operation program and a predetermined application program;
a predetermined device that is capable of operating by a predetermined function implemented by the operation program; and
a device control unit that drives the predetermined device by exclusively using the predetermined function.

18. A method of controlling a transmission type head mounted display device including an image display unit that displays an image to allow a user to visually recognize the image and is capable of transmitting external scenery, the method comprising:
determining a use environment of the head mounted display device; and
changing at least a portion of a predetermined function built into the head mounted display device in accordance with the determined use environment.

19. A computer program for controlling a transmission type head mounted display device including an image display unit that displays an image to allow a user to visually recognize the image and is capable of transmitting external scenery, the program causing a computer to implement:
a function of determining a use environment of the head mounted display device; and
a function of changing at least a portion of a predetermined function built into the head mounted display device in accordance with the determined use environment.
